(19) United States
(12) Patent Application Publication
(10) Pub. No.: US 2018/0039946 A1
(43) Pub. Date: Feb. 8, 2018

(54) Career Data Analysis Systems And Methods

(71) Applicant: Paysa, Inc., Palo Alto, CA (US)

(72) Inventors: Christopher William Bolte, Palo Alto, CA (US); Patrick Lloyd Harrington, JR., Boulder, CO (US); Nikhil Vadi Raj, Menlo Park, CA (US); Zachary Forsythe Poley, San Jose, CA (US)

(21) Appl. No.: 15/667,496

(22) Filed: Aug. 2, 2017

Related U.S. Application Data
(60) Provisional application No. 62/370,617, filed on Aug. 3, 2016.

(51) Int. Cl. G06Q 10/10; G06Q 50/20

(52) U.S. Cl. CPC G06Q 10/1053; G06Q 50/2057

(57) ABSTRACT

Example career data analysis systems and methods are described. In one implementation, a processing system receives data associated with a career path and receives data associated with a candidate's career history. The processing system determines at least one of a suggested career position or a suggested salary associated with the candidate based on the data associated with the career path and the data associated with the candidate's career history.

### RELATED APPLICATION

This application claims the priority benefit of U.S. Provisional Application Ser. No. 62/370,617, entitled “AI-Based Job Recommendation Engine,” filed on Aug. 3, 2016, the disclosure of which is hereby incorporated by reference herein in its entirety.

### TECHNICAL FIELD

The present disclosure relates to systems and methods that analyze career trends including position histories and salary histories from different sources to provide career suggestions or salary suggestions.

### BACKGROUND

The labor market represents a dynamic environment with regards to employee compensation and career growth. The career path versus compensation space is a very complex environment, with a large number of interdependent variables involved. Determining the salary and job title for an individual being hired for a particular position depends on multiple variables such as the individual's education, work experience and skill set, and the current salary trends in a particular industry. This complexity precludes a “one size fits all” approach to determining the salary and job title for a new hire. Instead, this determination process is a procedure considers the different variables associated with the labor market.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of a career data analysis system.

FIG. 2 is a block diagram depicting another embodiment of a career data analysis system.

FIG. 3 is a block diagram depicting an embodiment of a processing system used to implement certain functions of a career data analysis system.

FIG. 4A is a block diagram depicting an embodiment of a data analysis module associated with a career data analysis system.

FIG. 4B is a block diagram depicting an operational overview of an embodiment of a signal extraction module.

FIG. 5 is a flow diagram depicting an embodiment of a method to determine a career position suggestion or a salary suggestion.

FIGS. 6A-6C represent a flow diagram depicting an embodiment of a method to determine a career position suggestion or a salary suggestion.

FIG. 7 is a flow diagram depicting an embodiment of a method to recommend complimentary skills.

FIG. 8 is a flow diagram depicting an embodiment of a method to suggest a future career path projection.

FIG. 9 is a flow diagram depicting an embodiment of a method to recommend a job that increases the likelihood of advancement within a company.

FIG. 10 is a block diagram depicting an embodiment of an artificial intelligence-based career data analysis system.

FIG. 11 is a data flow diagram depicting an embodiment of a method to implement deep unsupervised learning associated with career data analysis.

FIG. 12 is a data flow diagram depicting an embodiment of a method to determine approximate nearest professionals.

FIG. 13 is a block diagram depicting an embodiment of a system configured to join disparate data sources.

FIG. 14 is a block diagram depicting an embodiment of an artificial intelligence-based job recommendation engine configured to match a candidate with at least one job.

FIG. 15 is a block diagram depicting an embodiment of an artificial intelligence-based skill recommendation engine configured to provide a personalized skill recommendation to a candidate.

FIG. 16 is a schematic diagram depicting an embodiment of an artificial intelligence-based recommendation engine configured to provide a personalized skill recommendation to a candidate.

FIG. 17 is a schematic diagram depicting a tree diagram generated by an embodiment of an artificial intelligence-based reinforcement learning engine configured to determine backwards or forwards feasibility associated with a career path.

FIG. 18A is a graphical representation of results that may be presented by an embodiment of an artificial intelligence-based recommendation engine.

FIG. 18B is a block diagram depicting an embodiment of an artificial intelligence-based reinforcement learning engine that is configured to determine backwards or forwards feasibility associated with a career path.

FIG. 19 is a block diagram depicting an embodiment of a static signal extraction system configured to extract a static genome signal from received data.

FIG. 20 is a block diagram depicting an embodiment of a labor market transition dynamics signal extraction system configured to perform signal extraction of transition dynamics associated with a labor market.

FIG. 21 is a flow diagram depicting an embodiment of a method to generate customized compensation information for an individual or job.

FIG. 22 is a schematic diagram depicting an embodiment of an algorithm configured to generate a company rank.

FIG. 23 is a block diagram depicting an embodiment of a career data analysis system.

FIG. 24 is a schematic diagram depicting a user interface as presented by an embodiment of a career data analysis system.

FIG. 25 is a schematic diagram depicting presentations of recommended skills as determined by an embodiment of a career data analysis system.

FIG. 26 is a schematic diagram depicting alternate presentations of recommended skills as determined by an embodiment of a career data analysis system.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein disclose a system based on a core engine that includes artificial intelligence (AI), reinforcement learning, data fusion, and probabilistic algorithms and associated estimation methods. As discussed herein, this system provides a user with comprehensive information about career and salary trends based on information processed from multiple datasets and/or multiple data sources. The system presented herein includes a processing engine that uses a number of analysis techniques to process data associated with career goals and associated salary trends. This system may be used, for example, by human resources (HR) personnel to estimate salaries commensurate with the qualifications and experience of new hires. Additionally, this system can be used by an individual looking for a new position, exploring a new job, or exploring a new career track. In some embodiments, the individual might be looking for information that includes career track progression along with an associated projected salary estimate.

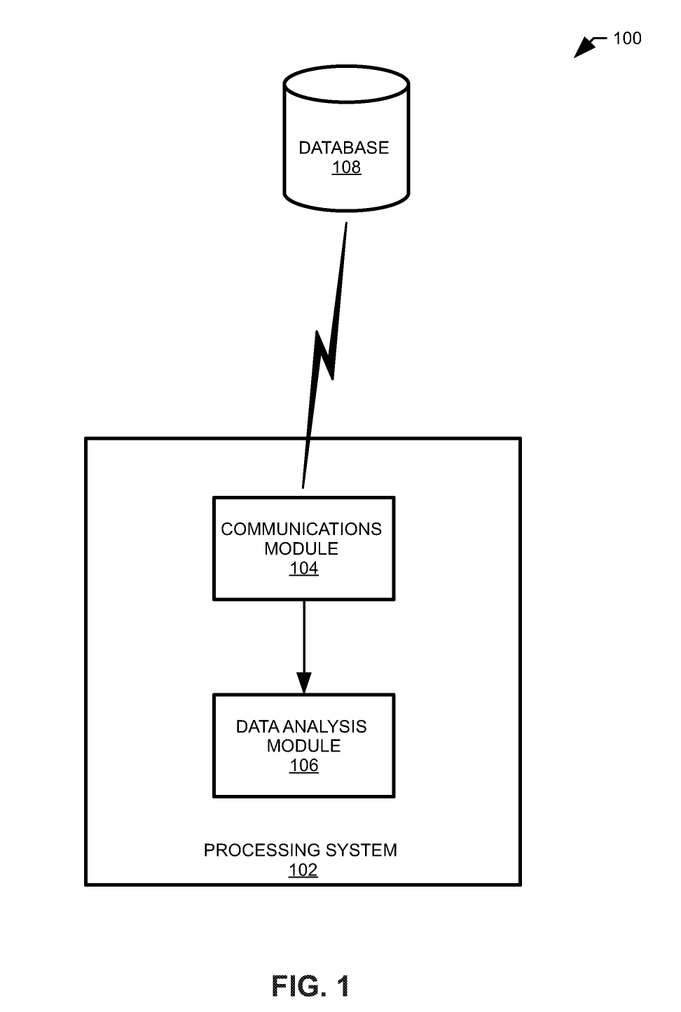

FIG. 1 is a block diagram depicting an embodiment of a career data analysis system 100. In some embodiments, career data analysis system 100 includes a processing system 102 that is configured to perform various processing functions as described herein. Processing system 102 includes a communications module 104 configured to receive data from a database 108. In some embodiments, data stored in database 108 may include data associated with a career path and data associated with a candidate's career history. The data associated with the career path may include, but is not limited to, company-specific data, geographic location, local demand and supply information, and company-specific compensation histories. The data associated with the candidate's career history may include, but is not limited to, the candidate's career history, the candidate's educational history, the candidate's compensation history, the candidate's current job title, the candidate's current salary, the candidate's current skill set, and the candidate's current geographic location.

In some embodiments, communications module 104 may also send and receive data with other devices, components, systems, and the like contained within processing system 102 or located outside processing system 102. In some embodiments, database 108 may be a remote database, for example, a cloud-based database. In other embodiments, database 108 may be a local database, for example, an on-site database. In particular embodiments, database 108 may include resumes, metadata of companies, personal compensation data, and so on. Processing system 102 also includes a data analysis module 106 that may be coupled to communications module 104 and configured to receive data from communications module 104.

In some embodiments, data analysis module 106 is configured to perform analysis on data received from communications module 106, to include artificial intelligence (AI)-based analysis methods, machine learning methods, and the like. In particular embodiments, data analysis module 406 is configured to present analytical results in the form of job recommendations for the candidate, salary recommendations for the candidate, and the like. In some embodiments, the job recommendations and the salary recommendations may be personalized to the candidate based on the data associated with the career path and the data associated with the candidate's career history. Details of the personalization process are provided herein.

In some embodiments, data received by communications module 104 from database 108 may include data associated with a career path and data associated with a candidate's career history. The data associated with the career path may include but is not limited to company-specific data, geographic location, local demand and supply information, and company-specific compensation histories. The data associated with the candidate's career history may include but is not limited to the candidate's career history, the candidate's educational history, the candidate's compensation history, the candidate's current job title, the candidate's current salary, the candidate's current skill set, and the candidate's current geographic location.

In some embodiments, data analysis module 106 is configured to process the data associated with the career path and the data associated with the candidate's career history to determine a suggested career position for the candidate, a salary suggestion associated with the candidate, or both. In particular embodiments, results from data analysis module 106 (i.e., the suggested career position or the salary suggestion) may be used by human resources (HR) personnel to determine an appropriate job title or compensation package for a prospective new hire or an existing candidate who is eligible for a promotion. As described herein, the term “career position” may be used interchangeably with “job” or other similar terms. Results from data analysis module 106 may also be used by a candidate looking for a job position along a specific career track. In some embodiments, the suggested career position or the suggested salary may be personalized to the candidate based on the data associated with the career path and the data associated with the candidate's career history.

In some embodiments, data associated with a career path or data associated with a candidate's career history may be categorized and defined as career data as used herein. A set of some of the features that may be included in career data analysis system 100 is given below. A detailed description of these features is provided herein.
Using data associated with past and present career trends to compensate for a dynamically-changing job market.
An ability to distinguish between a professional candidate and a student candidate and processing data accordingly.
An ability to recommend complementary skills to a candidate that might allow the candidate to potentially increase their market salary.
An ability to recommend career paths that increase a candidate's chance of getting a job.
An ability to recommend a job that increases the likelihood (or odds) of advancement for a candidate and corresponding salary increases within a company.
An ability to suggest at least one future career path recommendation to a candidate.

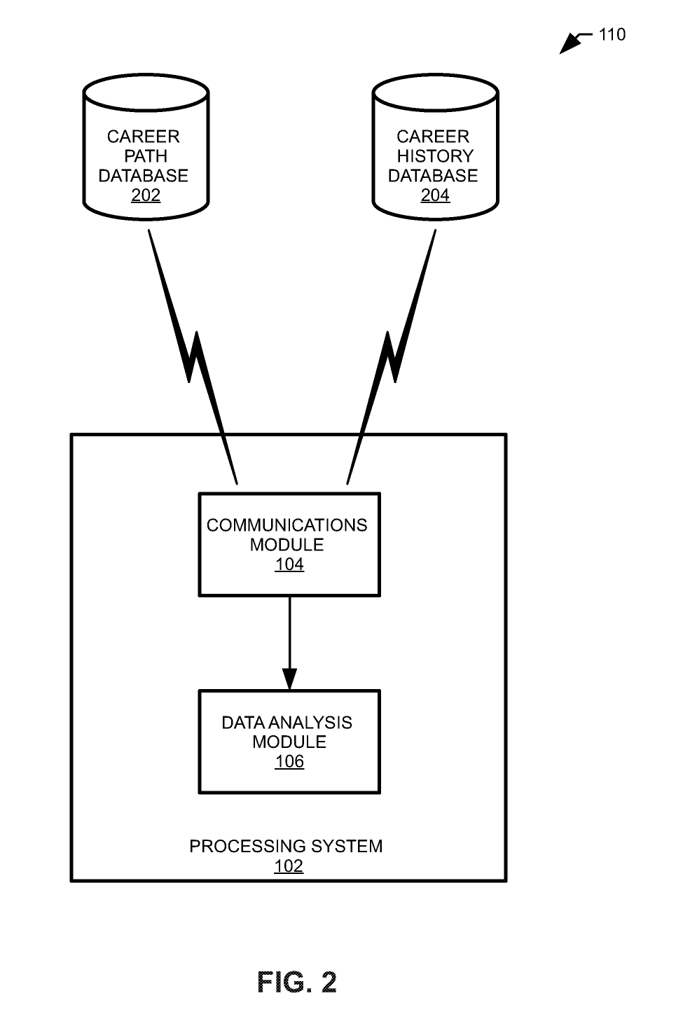

FIG. 2 is a block diagram depicting another embodiment of a career data analysis system 200. In some embodiments, career data analysis system 200 includes processing system 102, which further includes communications module 104 and data analysis module 106. Processing system 102, communications module 104 and data analysis module 106 perform similar functions as in the description of FIG. 1.

In some embodiments, communications module 104 is configured to receive data associated with a career path from a career path database 202, and data associated with a candidate's career history from a career history database 204. Although FIG. 2 shows two databases (career path database 202 and career history database 204) as an example, the systems and methods described herein are not limited to two such databases. Some embodiments of career data analysis system 200 may include any number of different kinds of databases storing a variety of data types to include company information, job title information, geographic location data, and location-specific promotion schedules and timing. In particular embodiments, databases associated with career data analysis system 200 may store data that includes compensation pricing model structures, data (also known as “signals”) associated with evolution through future roles in an organization, educational status data, and professional attributes data. An example of data associated with evolution through future roles in an organization as relevant to a candidate are skills that professionals at a more advanced stage in their career than the candidate possess that the candidate still has to acquire or develop. In some embodiments, career path database 202 may be a remote database such as a cloud database. In other embodiments, career path database 202 may be a local database. In some embodiments, career history database 204 may be a remote database such as a cloud database. In other embodiments, career history database 204 may be a local database. The data associated with the career path may include but is not limited to company-specific data, geographic location, local demand and supply information, and company-specific compensation histories. The data associated with the candidate's career history may include but is not limited to the candidate's career history, the candidate's educational history, the candidate's compensation history, the candidate's current job title, the candidate's current salary, the candidate's current skill set, and the candidate's current geographic location. Data analysis module 106 is configured to process the data associated with the career path and the data associated with the candidate's career history to determine a suggested career position for the candidate, a salary suggestion associated with the candidate, or both. Results from data analysis module 106 (i.e., the suggested career position or the salary suggestion) may be used by HR personnel to determine an appropriate job title or compensation package for a prospective new hire or an existing candidate who is eligible for a promotion. Results from data analysis module 106 may also be used by a candidate looking for a job position along a specific career track.

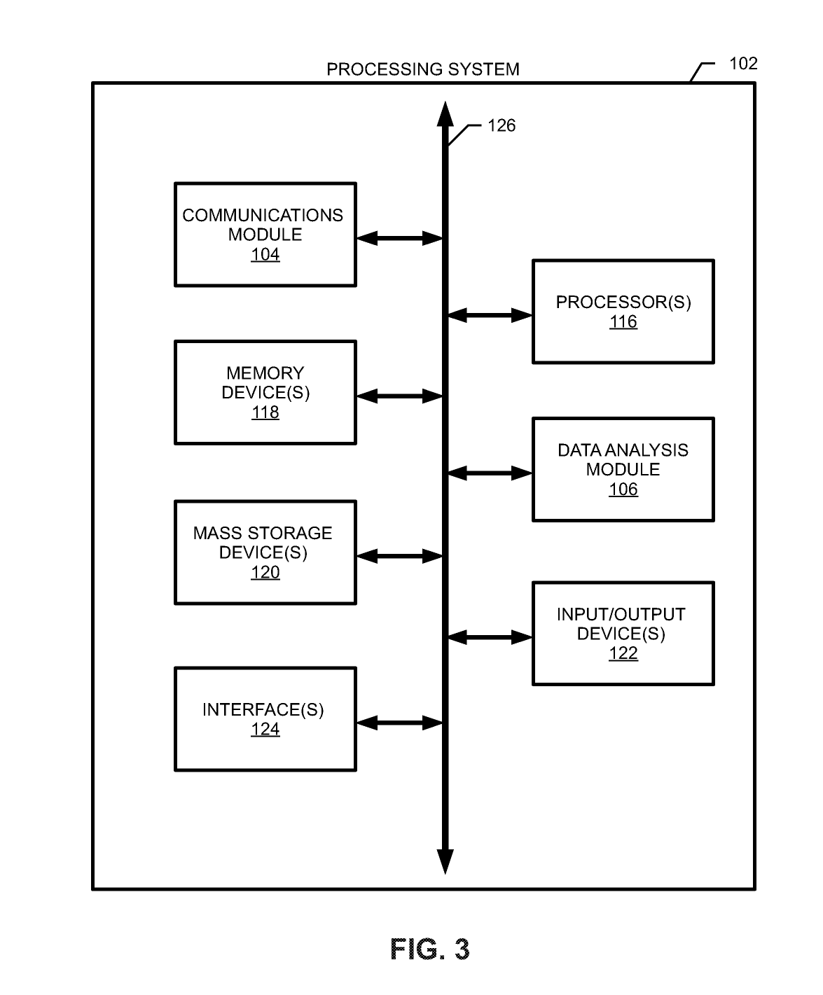

FIG. 3 is a block diagram depicting an embodiment of processing system 102 used to implement certain functions of a career data analysis system such as career data analysis system 100. In some embodiments, processing system 102 includes communications module 104 as described previously. Communications module 104 may be configured to communicate, for example, with a database such as database 108, via a network connection or any other type of communication link. In some embodiments, the network connection used by communications module 104 with the database may be a local area network. In other embodiments, the network connection used by communications module 104 to communicate with the database may be a public network such as the Internet. Communications module 104 may be configured with appropriate interfaces to communicate using different protocols across different types of networks or communication links. For example, communications module 104 may include a network interface to allow communications module 104 to communicate with a public network such as the Internet. In some embodiments, the network interface associated with communications module 104 may be an Ethernet interface.

In some embodiments, processing system 102 includes one or more processors 116 that are configured to perform processing functions that include but are not limited to mathematical and arithmetic computations or any other similar computational functions. Processor 116 may include any type of microprocessor, microcontroller, digital signal processor (DSP), field-programmable gate array (FPGA), or any other processing device. Processing system 102 may also include one or more memory devices 118 that are configured to store data in any combination of volatile or non-volatile formats. Examples of memory device 118 include random access memory (RAM), read-only memory (ROM), NAND flash memory, and the like.

Processing system 102 also includes data analysis module 106. As described earlier, data analysis module 106 is configured to receive and analyze data associated with a career path and data associated with the candidate's career history from communications module 104. Based on analysis of the data by data analysis module 106, the data analysis module 106 can determine a suggested career position for the candidate, a salary suggestion associated with the candidate, or both. In some embodiments, data analysis module 106 may implement one or more algorithms such as artificial intelligence algorithms, machine learning algorithms, and the like. Details about the operation of data analysis module 106 are provided herein. In particular embodiments, processing system 102 may include one or more mass storage devices 120 that include any combination of magnetic hard disk drives and/or solid-state drives. In some embodiments, mass storage devices 120 are configured to store data in a non-volatile format for access at a later time.

One or more input/output devices 122 may also be included in processing system 102. In some embodiments, input/output devices 122 may include any combination of keyboards, computer mice, computer video terminals or screens, audio input/output devices (microphones and speakers), touchscreens, or any other device that may allow a user of career data analysis system 100 to interact with components of career data analysis system 100.

Processing system 102 may also include one or more interfaces 124 that are configured to allow coupling between processing system 102 and other external devices. Interfaces 124 may include, for example, one or more universal serial bus (USB) ports, IEEE 1394 (Firewire) ports, IEEE 802.11 (WiFi) interfaces, and so on. In some embodiments, the different subcomponents of processing system 102, as described herein, may be each be coupled to a central data bus 126 that is configured to transmit communication signals and data between the different subcomponents of processing system 102.

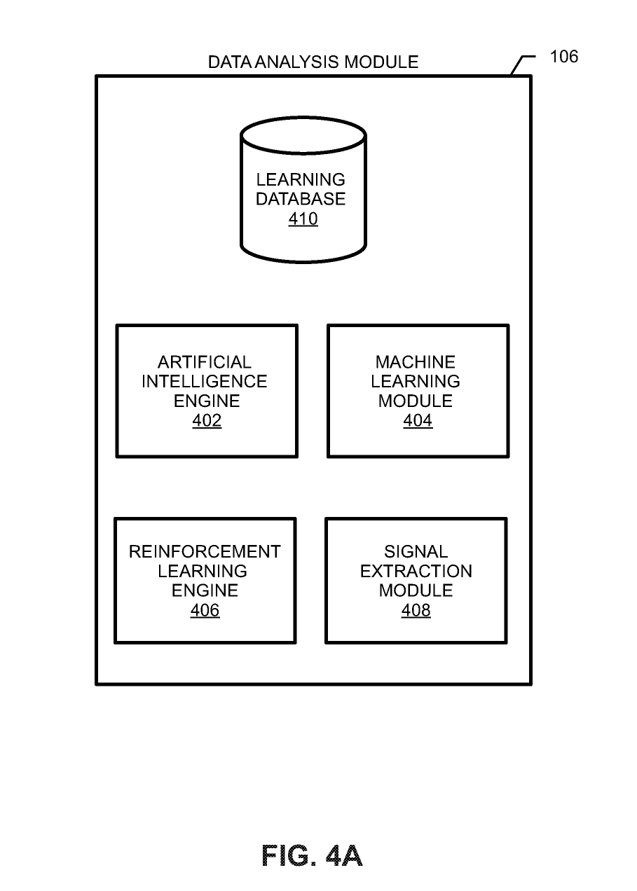

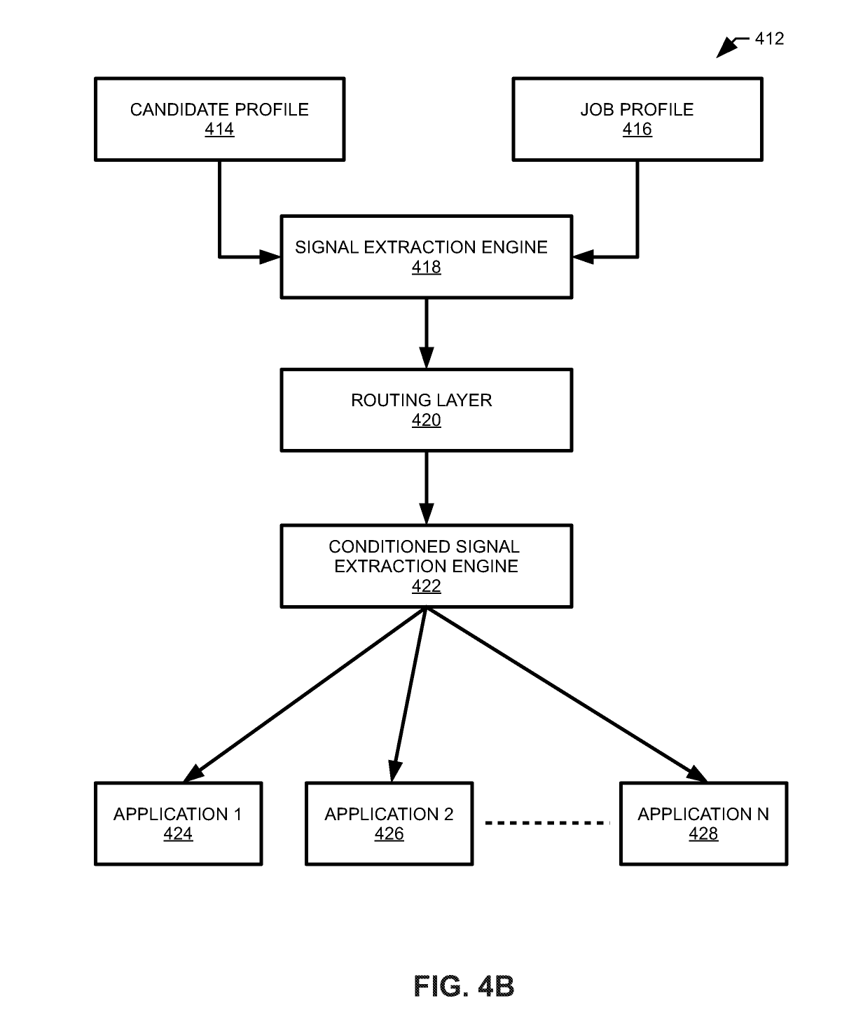

FIG. 4A is a block diagram depicting an embodiment of data analysis module 106 associated with career data analysis system 100. In some embodiments, data analysis module 106 may include an artificial intelligence engine 402 that is configured with artificial intelligence algorithms that serve to implement one or more of the functionalities of career data analysis system 100 as described herein. In some embodiments, artificial intelligence engine 402 may implement functions that match a candidate with a job. In some embodiments, artificial intelligence engine 402 may be configured to match a candidate with a particular salary or pay scale.

In particular embodiments, data analysis module 106 includes a machine learning module 404 that is configured to implement functions such as high-dimensional functional regression modeling on data to understand employee (e.g., candidate) compensation or wages, and implementing models to predict employee behavior such as time to quit, time to promotion, and time to lateral move. A reinforcement learning engine 406 may also be included in data analysis module 106. In some embodiments, reinforcement learning engine 406 may be configured to provide user results that are uniquely matched to a query generated by the user related to career data analysis (such as career path, job position, salary/compensation, and so on). In particular embodiments, reinforcement learning engine 406 may implement algorithms that enable career data analysis system 100 to determine substantially optimal results for a user-generated query. For example, reinforcement learning engine 406 may be configured to present suggestions in response to a user query that are likely to maximize the future career goals of the user or candidate.

A signal extraction module 408 may also be included in data analysis module 106. In some embodiments, signal extraction module 408 may be configured to extract and process signals (i.e., data) associated with a candidate's career history and data associated with a career path from the respective data sources as described herein. In some embodiments, the extracted data associated with the career path may include job title, required skills, job location, and so on. In some embodiments, the extracted data associated with the candidate's career history may include educational history, career history, current job title, current compensation, compensation history, and so on. In particular embodiments, an output of signal extraction module 408 may be referred to as a static genome signal.

In some embodiments, a static genome signal may also be referred to as a “professional signal.” In particular embodiments, a static genome signal may be derived from a candidate's resume. The static genome signal may contain canonicalized elements such as universities the candidate attended, the companies the candidate has worked for, geographic locations where the candidate has worked, and so on. Such a characterization of the static genome signal allows this signal to be used as input to a machine learning algorithms, where the static genome signal can be referred to as a “DNA signal” used by the machine learning algorithms. The data associated with a static genome signal is a unique characteristic of a candidate, and thus forms a genetic fingerprint (i.e., a DNA-like structure) that can be associated with the candidate's career history.

In some embodiments, signal extraction module 408 may be configured to generate a static genome signal (i.e., a professional signal) based on data associated with a career path or data associated with a candidate's career history that may include, for example, company attributes, title/position attributes, locality attributes, people attributes, and latent attributes. Company attributes may include, for example, a company profile with regards to the business of the company, available areas of work, and so on. Title/position attributes relate to a specific job position or title. Locality attributes are associated with specific local geographic information (for example, cost of living, taxes, demand for a particular skill set versus the available supply, and so on). People attributes may be associated with the distribution of signals of professionals in a specific company that perform the same or a similar role as the specific title or position. Finally, latent attributes include other variables associated with the specific position or title such as “geometrically” similar career paths or titles represented in non-Euclidean spaces. In some embodiments, the term “signals of professionals” as associated with a candidate may include professional signals or professional data derived from the candidate's resume. For example, a set comprising signals of professionals for a particular candidate may include the candidate's skill set, the schools attended by the candidate, the number of years' experience the candidate has in the workforce, and any professional and academic pedigrees associated with the candidate. In some embodiments, signals of professionals provide a geometric characterization (from a mathematical perspective) and tolerance of risk and success throughout a candidate's career. These signals are derived from the candidate's resume using signal extraction techniques, and may be included in the characterization of the candidate's profile.

In some embodiments, data analysis module 106 may include a learning database 410 that is configured to store data associated with machine learning, artificial intelligence algorithms or any similar methods that might be implemented by data analysis module 106 or any of its subsystems as described herein. In some embodiments, there may be an overlap between the different functions as implemented by the different subsystems of data analysis module 106.

FIG. 4B is a block diagram depicting an operational overview 412 of an embodiment of signal extraction module 408. In some embodiments, a signal extraction engine 418 reads in data from a candidate profile 414 and data from a job profile 416. In some embodiments, candidate profile 414 may include data associated with the candidate's career history, and job profile 416 may include data associated with a career path, to include job listings. In some embodiments, data associated with job profile 416 may be received from open-source job sites in the public domain. In particular embodiments, data associated with candidate profile 414 may be received from partnerships with recruiting companies that store candidate resumes and other candidate data. Particular embodiments of signal extraction module 408 may also receive compensation data received from partnerships with recruiting companies as well as compensation data available in the public domain (e.g., from .edu or .gov websites). In some embodiments, data associated with candidate profile 414 and job profile 416 may be in the form of text, to include formatted documents such as resumes or curricula vitae.

In some embodiments, signal extraction engine 418 is configured to extract candidate profile signals from candidate profile 414 that may include the candidate's educational history, the candidate's career path, the candidate's pay history, the candidate's current position, the candidate's skill set, and so on. In particular embodiments, signal extraction engine 418 is configured to extract job profile signals from job profile 416 that may include one or more job listings, the respective skills required, the expected compensation packages, and so on. The output generated by signal extraction engine 418 is received by a routing layer 420 that is configured to place the output generated by signal extraction engine 418 in an appropriate category. For example, routing layer 420 may determine where a particular piece of data (i.e., a signal) after processing by signal extraction engine 418 falls with respect to one or more economic regions. In some embodiments, economic regions may include datasets associated with different occupations or specializations. For example, in the case of a registered nurse, different economic regions can be constructed based on specialization, such as neurosurgery, gastrointestinal, emergency room, and the like. Or, a lawyer may be classified in a different economic category than, for example, an accountant.

In some embodiments, outputs from routing layer 420 may be received by a conditioned signal extraction engine 422 that is configured to canonicalize the data and create one or more hash signatures associated with the data. The concept of hash signatures is described herein. A hash signature is a normalized set of measures associated with a particular data element that signify a relevance of the data element with respect to one or more data fields. For example, a relevance of a candidate's skill set to one or more job listings can be represented as a set of integer values that provides a measure of how closely-matched the candidate's skill set to a particular job. Hash signatures created by conditioned signal extraction engine 422 from data received from routing layer 420 are referred to as routed hash signatures, or routed hashes.

The flexibility of career data analysis system allows the system to accept a large variety of input data and categorize that data depending on the desired application. This aspect is realized by application-specific outputs generated by conditioned signal extraction engine 422. For example, an application 1 424, an application 2 426, through an application N 428 may be generated by conditioned signal extraction engine 422. The nature of each of application 1 424 through application N 428 is flexible, and depends on the nature of the data being analyzed, as well as the desired outputs. For example, application 1 424 may provide salary listings for one or more prospective jobs that match the candidate's profile and desired salary, application 2 426 may present skill sets that the candidate does not possess but may be useful in expanding and growing the candidate's career (i.e., desirable skill sets), and so on. Additionally, application N 248 may provide a listing of jobs that are similar to the candidate's current job.

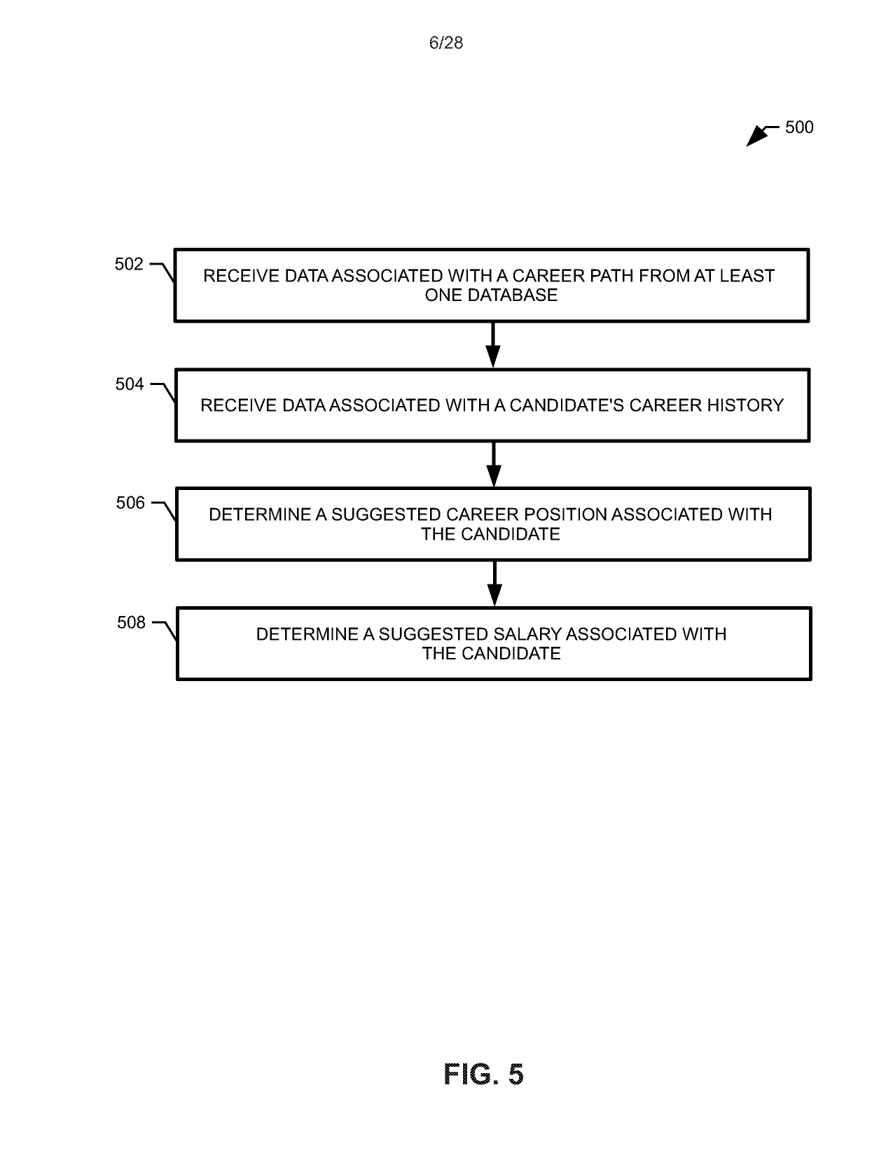

FIG. 5 is a flow diagram depicting an embodiment of a method 500 to determine a career position suggestion or a salary suggestion. At 502, the method receives data associated with a career path from at least one database. In some embodiments, the database may be similar to database 108. In particular embodiments, the database may include career path database 202. At 504, the method receives data associated with a candidate's career history. In some embodiments, data associated with the candidate's career history may be received from database 108. In other embodiments, data associated with the candidate's career history may be received from career history database 204.

At 506, the method determines a suggested career position associated with the candidate. In some embodiments, the suggested career position may be determined from the results of processing performed on data associated with the career path and data associated with the candidate's career history by data analysis module 106.

At 508, the method determines a suggested salary associated with the candidate. In some embodiments, the suggested salary may be determined from the results of processing performed on data associated with the career path and data associated with the candidate's career history by data analysis module 106. Additional details regarding determining a suggested career position and a suggested salary are discussed below.

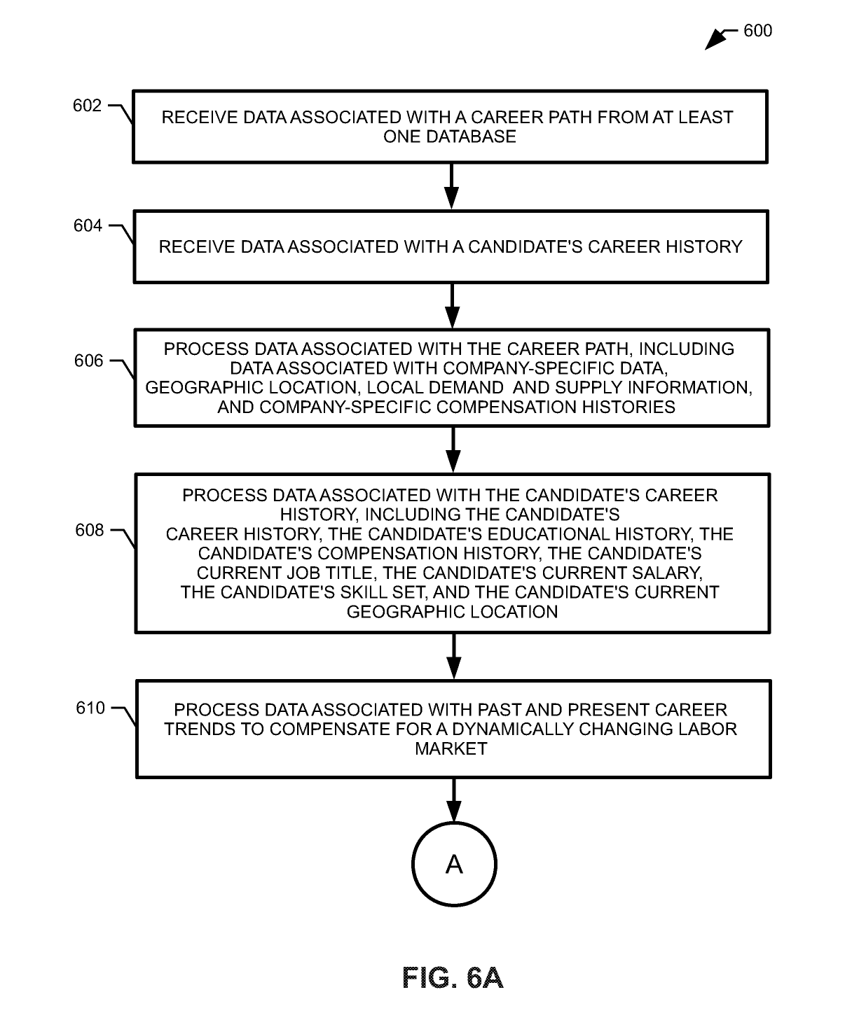

FIG. 6A represents a flow diagram depicting an embodiment of a method 600 to determine a career position suggestion or a salary suggestion. At 602, the method receives data associated with a career path from at least one database. In some embodiments, the database may be similar to database 108. In other embodiments, the database may include career path database 202. At 604, the method receives data associated with a candidate's career history. In some embodiments, data associated with the candidate's career history may be received from database 108. In other embodiments, data associated with the candidate's career history may be received from career history database 204.

At 606, the method processes data associated with the career path, including data associated with company-specific data, geographic location, local demand and supply information, and company-specific compensation histories. In some embodiments, this processing (and other subsequent processing) may be performed by data analysis module 106. The following describes example data and data parameters that may be included in the processing discussed herein.
Company-specific data: Different companies may have different compensation schemes that include, for example, base pay, stock options, benefits packages, time off, and so on. These company-specific parameters that may be included in processing data associated with the career path.
Geographic location: Since the cost of living is different in different geographic locations this is an important parameter to include in any analysis associated with career paths or salaries. For example, a company having an office at two different geographic locations may have different base pay compensation for their employees. Employees working in the geographic location with higher living costs may be compensated with a higher base pay than employees working in the geographic location with lower living costs.
Local demand and supply information: Geographic location may also determine the demand of a particular skill set in a particular area. This aspect may be considered while processing data associated with the career path.
Company-specific compensation histories: Different company profiles and associated compensation histories for a variety of career positions and career tracks may be included in the data processing functions.

Returning back to method 600, at 608, the method processes data associated with the candidate's career history, the candidate's educational history, the candidate's compensation history, the candidate's current job title, the candidate's current salary, the candidate's skill set, and the candidate's current geographic location. The following describes example data and data parameters that may be included in the processing discussed herein.
The candidate's career history: The candidate's career history plays a significant role in determining whether the candidate is qualified for a specific position as well as for determining the candidate's salary.
The candidate's current job title: The candidate's current job title may be used, for example, to determine whether a particular job position is a good match for the candidate.
The candidate's current salary: The candidate's current compensation can be factored in while determining a suggested job or compensation package.
The candidate's skill set: The diversity of the candidate's skill set can be included in any analysis while processing data associated with the candidate's career history.
The candidate's current geographic location: Data associated with the candidate's current geographic location may be considered for the variability in cost of living associated with different geographic locations, as discussed earlier.

At 610, the method processes data associated with past and present career trends to compensate for a dynamically changing job market. In some embodiments, it may be important to account for past and present career trends as the job market is seldom static. By processing data associated with past and present career trends, a more accurate and realistic set of results can be produced by data analysis module 106. In some embodiments, processing data associated with past and present career trends may involve progressive and regressive temporal data analyses as described herein. The method then proceeds to A, with a continued description in FIG. 6B.

FIG. 6B is a continued description of method 600. Starting at A, the method goes to 612, where the method checks to determine whether the candidate is a student. If the candidate is a student, the method proceeds to 614, where it determines a suggested career position associated with the student candidate. Next, at 616, the method determines a suggested salary associated with the student candidate. At 618, the method determines a future career path suggestion associated with the student candidate. If, at 612, the method determines that the candidate is not a student then the method goes to B with a continued description in FIG. 6C.

FIG. 6C is a continued description of method 600. Starting at B, the method proceeds to 620, where the method determines a suggested career position associated with the professional candidate. Next, at 622, the method determines a suggested salary associated with the professional candidate. Finally, at 624, the method determines a future career path suggestion associated with the professional candidate. Additional details regarding 620-624 are provided herein.

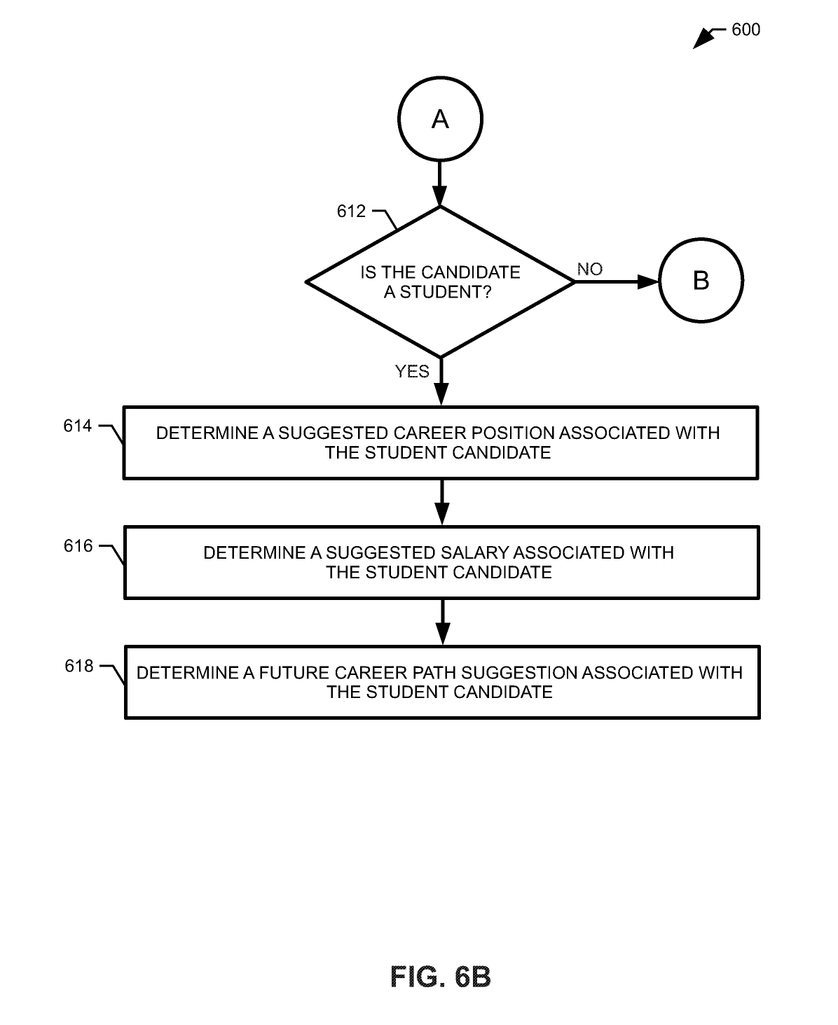

FIG. 7 is a flow diagram depicting an embodiment of a method 700 to recommend complimentary skills. At 702, the method receives data associated with a career path from at least one database. In some embodiments, the database may be similar to database 108. In other embodiments, the database may include career path database 202. At 704, the method receives data associated with a candidate's career history. In some embodiments, data associated with the candidate's career history may be received from database 108. In other embodiments, data associated with the candidate's career history may be received from career history database 204.

At 706, the method processes the data associated with the career path and the data associated with the candidate's career history using an artificial intelligence-based skill recommendation engine. Details of this processing are discussed in greater detail herein. In some embodiments, the processing functions may be performed by data analysis module 106. In particular embodiments, other processing algorithms such as machine learning methods may be used to process the data. Based on the results of the processing, the method, at 708, recommends complementary skills to the candidate that might allow the candidate to potentially increase their market salary.

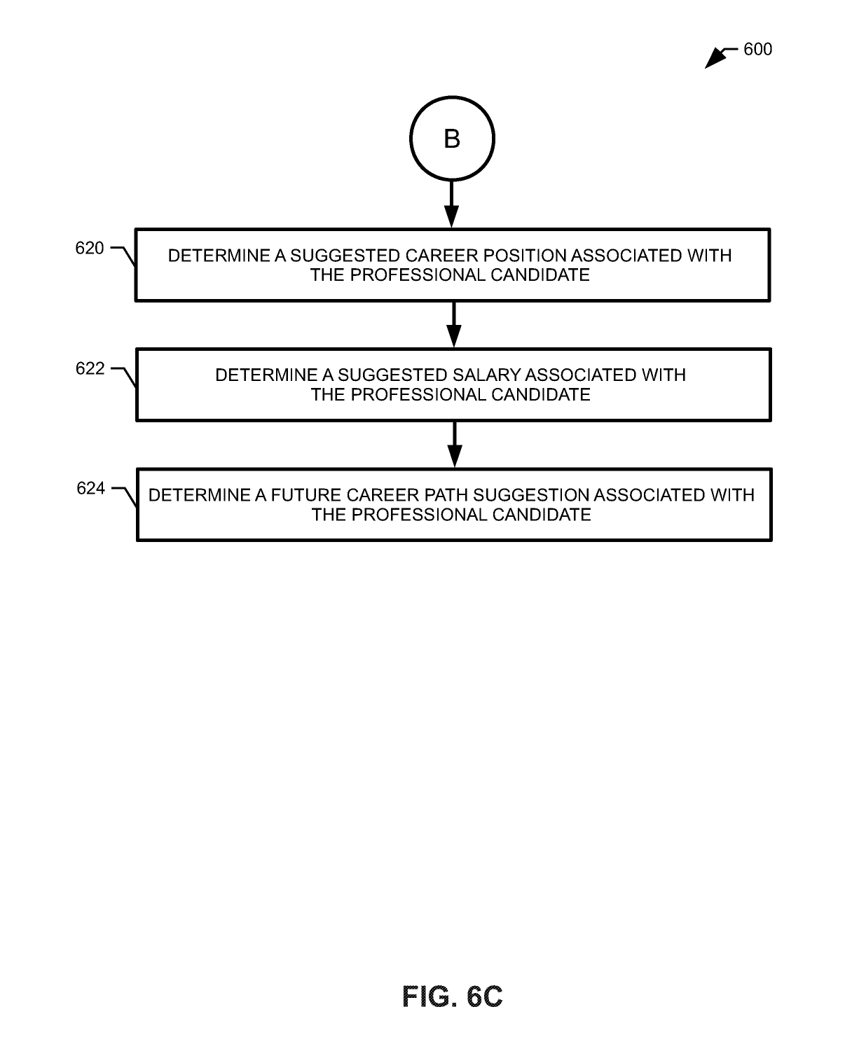

FIG. 8 is a flow diagram depicting an embodiment of a method 800 to suggest a future career path projection. At 802, the method receives data associated with a career path from at least one database. In some embodiments, the database may be similar to database 108. In other embodiments, the database may include career path database 202. At 804, the method receives data associated with a candidate's career history. In some embodiments, data associated with the candidate's career history may be received from database 108. In other embodiments, data associated with the candidate's career history may be received from career history database 204.

At 806, the method processes the data associated with the career path and the data associated with the candidate's career history using machine learning algorithms. Details of this processing are discussed herein. In some embodiments, the processing functions may be performed by data analysis module 106. Based on the results of the processing operation, the method, at 808, recommends career paths that increase the candidate's likelihood (or odds) of getting a job, and at 810 the method suggests a future career path projection to the candidate.

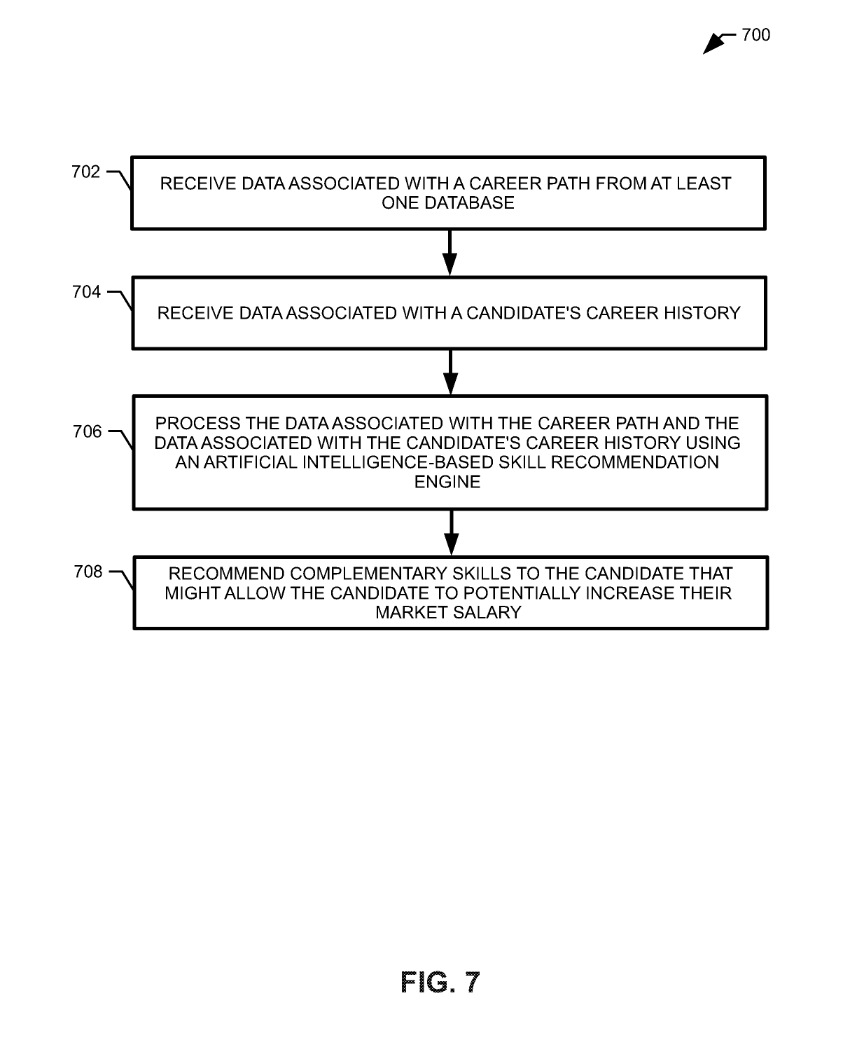

FIG. 9 is a flow diagram depicting an embodiment of a method 900 to recommend a job that increases the likelihood of advancement within a company. At 902, the method receives data associated with a career path from at least one database. In some embodiments, the database may be similar to database 108. In other embodiments, the database may include career path database 202. At 904, the method receives data associated with a candidate's career history. In some embodiments, data associated with the candidate's career history may be received from database 108. In other embodiments, data associated with the candidate's career history may be received from career history database 204.

At 906, the method processes the data associated with the career path and the data associated with the candidate's career history using artificial intelligence-based skill recommendation engine. Details of this processing are discussed herein. In some embodiments, the processing functions may be performed by data analysis module 106. Based on the results of the processing operation, the method, at 908, recommends a job that increases the likelihood of advancement for the candidate and corresponding salary increases within a company.

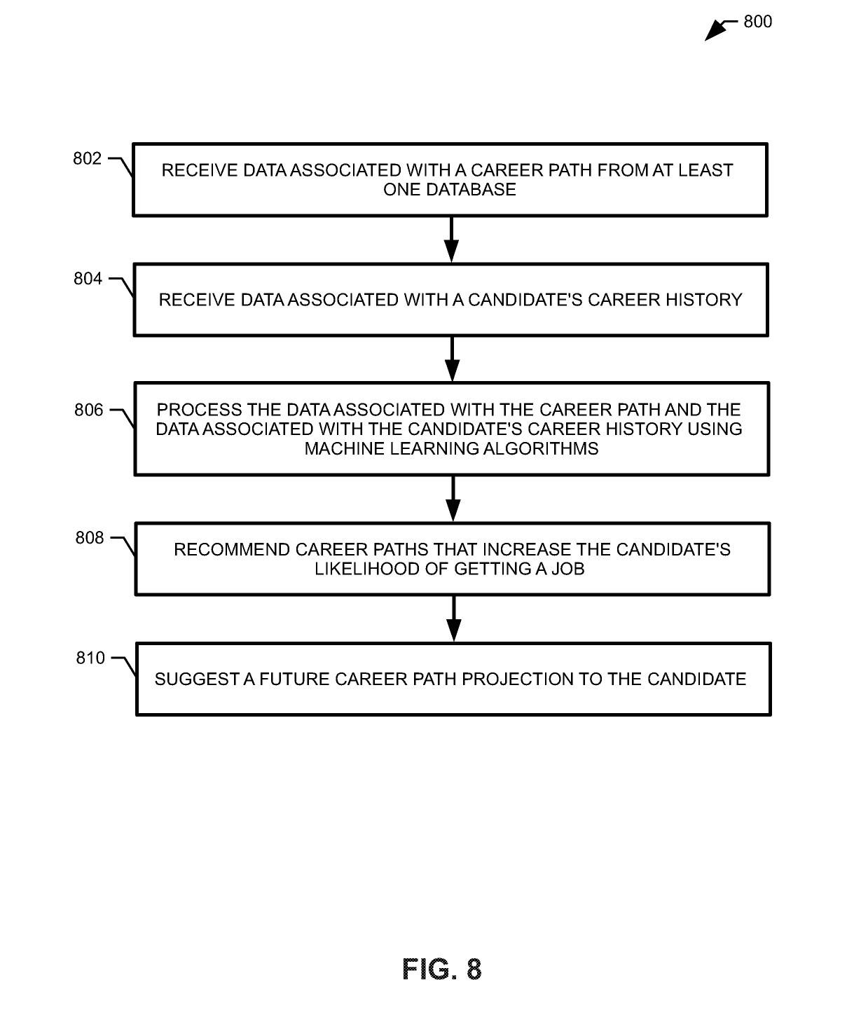

FIG. 10 is a block diagram depicting an embodiment of an artificial intelligence-based career data analysis system 1000. In some embodiments, artificial intelligence-based career data analysis system 1000 may be a part of data analysis module 106. Artificial intelligence-based career data analysis system 1000 may be configured to perform, among other functions, occupation or industry detection. In some embodiments, artificial intelligence-based career data analysis system 1000 may receive a raw job profile associated with a career path or a raw candidate profile or resume and use, for example, deep unsupervised learning methods to accordingly route or map the raw job profile or the raw candidate profile or resume to an appropriate region of an existing economy and the corresponding occupation type. In some embodiments, every job that is included in received data associated with a career path or every candidate profile that is included in received data associated with a candidate's career history is assigned a specific signature corresponding to the above routing or mapping. This allows for customized or personalized processing functions (such as data decomposition) to be performed on any such career data.

Some embodiments of artificial intelligence-based career data analysis system 1000 may include a reinforcement learning career goal/maximization engine 1002 that is configured to implement reinforcement learning algorithms to maximize a specific career goal. For example, a career goal may include increasing salary, attaining a particular job title, or acquiring a specific benefits package. In some embodiments, reinforcement learning career goal/maximization engine 1002 may implement reinforcement learning algorithms such as Markov Decision Processes (MPD) to determine one or more career options available to a candidate. For example:
Suppose a candidate is at a particular point A in their career. An MPD algorithm as implemented by reinforcement learning career goal/maximization engine 1002 may be used to determine career paths associated with most probable and highest earnings career paths from point A forward over time (for example, promotion paths within a company).
Suppose a candidate is at a point B in their career and they want to get to a point C, where point C is a desired career position (possibly a higher job title or a job with a higher compensation package as compared to the candidate's current position). An MPD algorithm as implemented by reinforcement learning career goal/maximization engine 1002 may be used to determine the most likely fastest, most probably and highest earnings paths that could take the candidate from point B to point C. For example, the candidate may want to be the vice president of a particular company at a specific location. Reinforcement learning career goal/maximization engine 1002 may present most likely relevant career paths for the candidate.

In some embodiments, reinforcement learning career goal/maximization engine 1002 may be always on in the sense that it is continually receiving data, performing processing functions, and updating the associated results. In particular embodiments, reinforcement learning career goal/maximization engine 1002 may provide insight into present and future recommendations and paths while also providing information such as the implication of taking certain actions (for example, a job change), while also recommending policies that maximize objective functions (such as potentially maximizing salary over a certain time period) or achieving certain career goals.

Artificial intelligence-based career data analysis system 1000 may also include an artificial intelligence engine 1004 that is configured to implement artificial intelligence algorithms and methods to process career data. In some embodiments, artificial intelligence engine 1004 performs functions such as latent signal matching using artificial intelligence to provide recommendations for jobs, skills that increase the likelihood of getting a job, career paths that may provide increased pay while increasing overall earning potential, and associated fluidity. Functions performed by the AI algorithms include:
Pricing someone a job: Providing an estimate of a compensation package that may be expected from a particular job. This may be provided to either a candidate or HR personnel. In some embodiments, pricing someone (i.e., a candidate) at a job may include processing one or more signals (i.e., data) associated with the candidate's profile and data associated with one or more job profiles. In particular embodiments, data associated with the candidate's profile or data associated with one or more job profiles may be modeled as, for example, a log normal probability distribution function by processing the signals using any combination of deep learning, generalized linear models, or functional regression models. The log normal probability distribution function may be characterized by parameters such as a conditional mean and a variance associated with the log normal probability distribution function. The characterization of the log normal probability distribution function may be used to determine an average price (i.e., an expected mean salary) associated with a job profile or a candidate profile (based on, for example, the conditional mean of the log normal probability distribution function), or a price range (i.e., an expected salary range) associated with a job profile or a candidate profile (based on, for example the variance associated with the log normal probability distribution function).
Matching someone to a job: Providing a job suggestion based on matching the job requirements with a candidate's qualifications.
Determining which skills a candidate should develop.
Determining similar professionals to an individual: Professionals with similar career histories, educational histories, job titles and so on.
Providing navigable paths through a new career and the “utility” gain along each path to include time, earnings, and so on.
Quantifying the “quality” of people and institutions: Providing measures based on company data (e.g., company ranking), or candidate ranking.

In some embodiments, artificial intelligence engine 1004 may be configured to communicate and exchange data with reinforcement learning career goal/maximization engine 1002.

In some embodiments, artificial intelligence engine 1004 may include an AI skill recommendation manager 1006, where AI is used as an abbreviation for artificial intelligence. AI skill recommendation manager 1006 may function as the engine for processing career data and providing job matches. AI skill recommendation manager 1006 may also be configured to provide suggestions that potentially provide increased compensation, career fluidity, increased earnings, and so on.

In some embodiments, artificial intelligence engine 1004 may include AI job-user matching engine 1008. AI job-user matching engine 1008 may be configured to process career data (i.e., data associated with a career path and data associated with a candidate's career history) and provide one or more potential job matches to a user (i.e., a candidate, human resources personnel or any other user of the system).

In some embodiments, artificial intelligence engine 1004 may include AI job-user compensation engine 1010 that may be configured to process career data (i.e., data associated with a career path and data associated with a candidate's career history) and provide one or more potential compensation packages associated with a specific job to a user (i.e., a candidate, human resources personnel or any other user of the system).

Artificial intelligence-based career data analysis system 1000 may also include a statistical signal processing engine 1012 that is configured to process career data using statistical signal processing algorithms and methods. In some embodiments, statistical signal processing engine 1012 may include a spatio-temporal signal extraction services manager 1014 and a genetics user and job personalized compensation machine learning engine 1016. Together spatio-temporal signal extraction services manager 1014 and genetics user and job personalized compensation machine learning engine 1016 implement algorithms and methods in statistical signal processing, machine learning, high-dimensional functional regression modeling to understand employee compensation against over 10,000 features or latent features, and other Bayesian techniques to better understand the employee compensation process. In some embodiments, the 10,000 features or latent features may be a part of the signals (or data) that constitute a professional signal associated with a candidate. In particular embodiments, the 10,000 features or latent features may include job title data (also referred to as “signals”), data associated with the candidate's skill set, data associated with the candidate's educational achievements, risk tolerance data associated with the candidate, the candidate's rate of promotion, and professional and academic pedigrees earned by the candidate. In some embodiments, the 10,000 features or latent features may include machine learning derived signals that capture various latent geometries, including non-human interpretable signals (for example, signals encoded in machine language). In particular embodiments, a set of latent features (also referred to as latent signals) may include data that may not be apparently measurable, for example, the quality of employees working at a company. Using machine learning techniques, such as functional regression modeling, such data may be characterized with a measure and quantified.

In some embodiments, spatio-temporal signal extraction services manager 1014 may analyze data associated with the candidate's profile and one or more job profiles to generate, for example, covariance signals associated with a log normal probability distribution function that is used as a basis to model data. In particular embodiments, spatio-temporal signal extraction services manager 1014 may process the covariance signals using functional regressional modeling algorithms as a part of the process that matches the candidate with one or more jobs.

In some embodiments, genetics user and job personalized compensation machine learning engine 1016 is configured to process the user's professional signal in a particular role and leverage geometric and density estimation methods to understand the distribution of compensation of like professionals in a similar role at the company where the candidate is currently employed.

In some embodiments, statistical signal processing engine 1012 may include a natural language processing manager 1018 that is configured to implement natural language processing algorithms to process career data. For example, natural language processing methods may be used to extract information and key words from a candidate's resume or from a job description. Natural language processing manager 1018 may also include a fuzzy join canonical services manager 1020 and a static signal extraction services manager 1022 that are configured to implement algorithms in natural language processing, information retrieval, geometric machine learning clustering methods, spectral latent techniques of document merging, and so on.

In some embodiments, static signal extraction services manager 1022 is configured to parse data associated with a candidate profile, or one or more job profiles, and extract relevant keywords associated with the data, while fuzzy join canonical services manager 1020 is configured to process the keywords and generate a set of common features associated with similar data types. For example, candidates who have attended the University of California, Berkeley, may have certain common nomenclature used in their respective resumes or candidate profiles. Fuzzy join canonical services manager 1020 extracts common words or semantics associated with the candidate profiles (e.g., Berkeley Engineering), and determines the common nomenclature based on data from, for example, educational databases. Fuzzy join canonical services manager 1020 may then store these common features as a part of a dataset that contains such standardized (normalized, canonicalized) data sets.

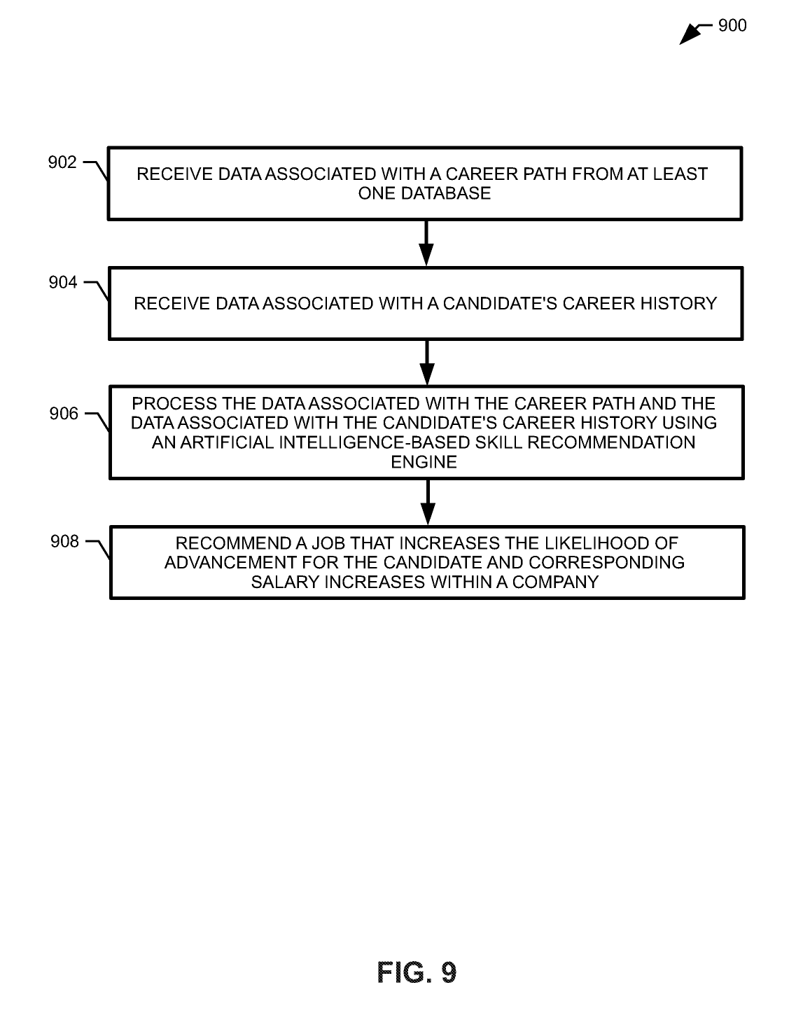

FIG. 11 is a data flow diagram depicting an embodiment of a method 1100 to implement deep unsupervised learning associated with career data analysis. In some embodiments, the deep unsupervised learning may include economic vertical and occupation detection or routing. In some embodiments, the term “economic vertical” may include an emergent signal of the data as output by a deep unsupervised earning algorithm where candidates with, for example, with nursing skills and degrees tend form an underlying signal in some region of space separate from law, operations research, accounting, and so on. The term “economic vertical” is used to denote a categorization or grouping of career data by occupation type.

In some embodiments, method 1100 may receive an input variable 1102 defined as:

xᵢ={skills,degrees}

Input variable 1102 may include, for example, skills and degrees extracted from a raw job profile or raw candidate profile. In the event that a raw job profile is being analyzed, skills may include the required or desired job skills while degrees may include required educational qualifications. In the event that a raw candidate profile is being analyzed, skills may include the candidate's skill set while degrees may include the educational degrees earned during the candidate's educational history. In some embodiments, natural language processing algorithms may be used for raw text parsing and signal formation.

A first step 1104 associated with method 1100 involves receiving input variable 1102 by an input node 1106. This data from input node 1106 is used to create m economic regions of geometric embedding, denoted as an economic region node 1 1108, an economic region node 2 1110, an economic region node 3 1112, through an economic region node m 1114. The output of each of economic region node 1 1108 through economic region node m 1114 is the relative distance of how similar or dissimilar the resumes comprising each economic region are. For example, for a given economic region, the output of each economic region of geometric embedding determines, for example, the similarity of a job query or a profile query to professions such as medical, law, accounting, consulting and so on.

In some embodiments, first step 1104 determines the relative similarity of the input signal associated with a particular candidate or a particular job to various parts of the economy. The geometric distance of this signal to the subspace spanning each of these respective nodes (with each node denoting a particular professional industry) enables a comparison of “like” or “unlike” (i.e., similar or dissimilar) that signal is when the signal is used to form an aggregate nearest K signals which feeds forward down to 1116. If the degree of likeness at 1104 if not similar enough to existing professional geometric representations the professional/job is considered “non-professional” and discarded from further analyses.

In some embodiments, information from each of economic region node 1 1108 through economic region node m 1114 is respectively routed to an input node 1118 associated with a second step 1116. At input node 1118, an intermediate signal 1120 is constructed:

sᵢ=ƒ(g₁(xᵢ),g₂(xᵢ), . . . ,gₘ(xᵢ))

In some embodiments, intermediate signal 1120 is constructed as a function ƒ operating on m functions g₁(xᵢ) through gₘ(xᵢ), where xᵢ is derived from the definition of input variable 1102. In particular embodiments, intermediate signal 1120 may be forming the top k penalized distances from each of the m input signals to form a k-dimensional economic signature. Step 1116 also builds a cluster set 1122 containing c clusters denoted as cluster 1 1124, a cluster 2 1126, a cluster 3 1128, through a cluster c 1130, where c<m. Cluster 1 1124 through cluster c 1130 are the canonical regions of the economy for professionals and each input signal gets mapped to one of these primarily and another secondarily; where the primary mapping is related to participation in the economy and secondary region of participation. The primary and secondary mappings performed in this step are consistent with the definitions of economic vertical categorizations as described earlier.

At a third step 1132, an occupational signature 1144 is constructed, given by the equation:

oᵢ=h(ƒ(g₁(xᵢ),g₂(xᵢ), . . . ,gₘ(xᵢ)))

In some embodiments, occupational signature 1144 of a job or a user is constructed based on algorithms such as deep forward projection or clustering. Third step 1132 leverages skills or degrees to form clusters of occupations within that economic region, for example a cluster 1 1134, a cluster 2 1136, a cluster 3 1140, through a cluster c 1142. In particular embodiments, third step 1132 abstracts the occupation under the economic region of primary participation based on the skills or degrees. In third step 1132, individual jobs are denoted by cross-hatched circles within cluster 1 1134 through cluster c 1142. In some embodiments, a specific job 1138 may be mapped to as a suggested job based on career data processing. In some embodiments, the final signature of a nearest membership mapping (i.e., cluster formation) at step 1132 across all clusters (or nodes) associated with step 1116 comprise what is referred to as a “hash” signature of the occupation of a candidate or job. Varying degrees of granularity of the hash indicate deeper professional relationship when compared to an object (candidate or job) with more similar hash than a coarser one.

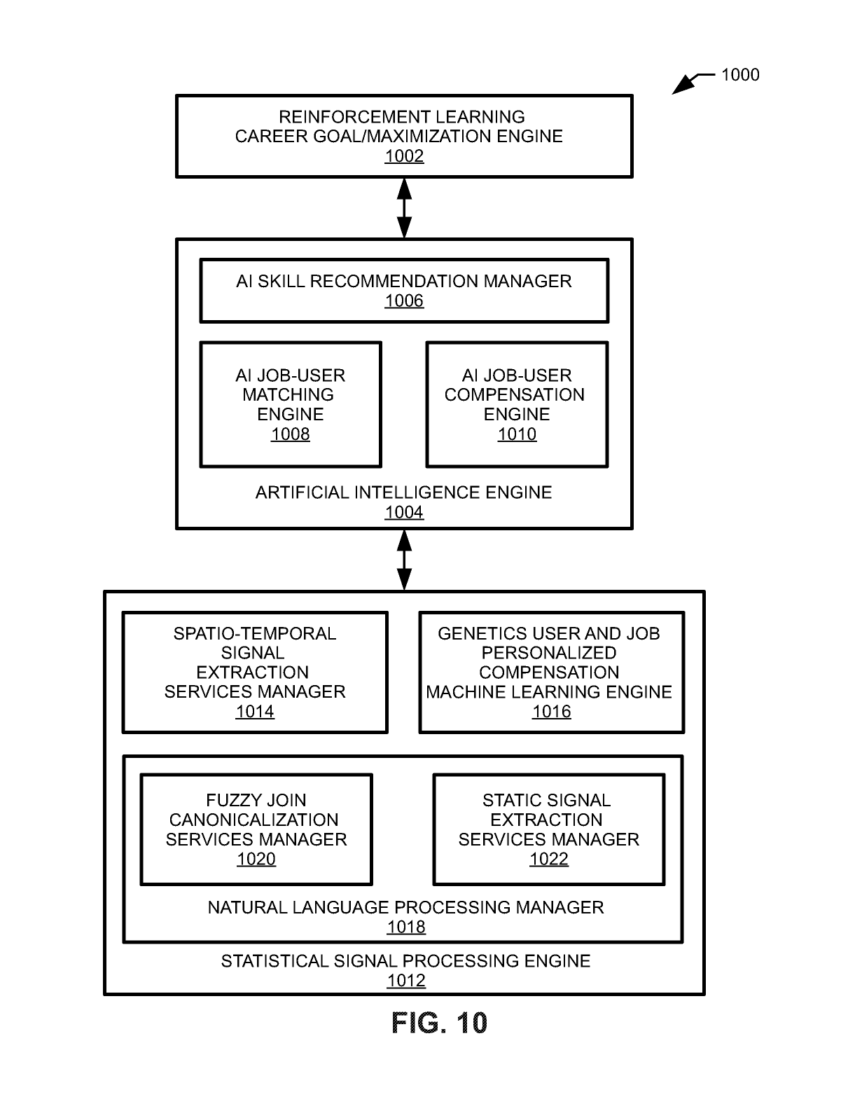

FIG. 12 is a data flow diagram depicting an embodiment of a method 1200 to determine approximate nearest professionals. In some embodiments, method 1200 starts with occupational signature 1144 that is associated with a specific user. This occupational signature may also be referred to as a user occupational signature. In some embodiments, method 1200 may operate on adjacent signals that are defined as signals (or data) containing metadata associated with a specific query or search (for example, a job search). In particular embodiments, an example of adjacent signals associated with a search such as “company=Google” would include data such as the number of employees associated with the company, whether the company is a public company, any employment patterns of the employees working at the company, potential competitors, and so on.

In some embodiments, user profile (or candidate profile) that may include a candidate's resume, work history, salary history, educational history and so on, along with adjacent signals derived offline and housed in various databases may be processed to generate a full genome signal 1202 given by the equation:

uᵢ=parsleyExtraction(profile)

In the above equation, the function parsleyExtraction( ) performs the function of constructing a genome signal from the user profile by extracting features from the candidate's profile as performed by, for example, static signal extraction manager 1022. The function parsleyExtraction( ) may also implement functionality associated with fuzzy join canonical services manager 1020. A combination of full genome signal 1202 and occupational signature 1144 are combined to generate an input signal 1204 given by {uᵢ, oᵢ}. Input signal 1204 is forwarded to an input node 1206, where input signal 1204 is processed to create a stochastic projection 1208 of input signal. In some embodiments, stochastic projection 1208 involves a stochastic projection of input signal 1204 into regions of space which are discretized, for example a discrete region 1 1210, a discrete region 2 1212, a discrete region 3 1214, and so on through a discrete region M 1216. This process of stochastic projection of input signal 1204 to M discrete regions is also associated with the creation of a hash signature. In some embodiments, a hash signature may be defined as a combination of the routing layer clustering memberships, where each layer's clustering membership may be denoted by an integer number, e.g., 5, 19, 17, 2, 22, 3, etc. In particular embodiments, a hash signature is an ordered array of data objects derived from a relevant data source such as a candidate profile or a job profile. In some embodiments, the ordering process is based on a relative normalized distance of a particular data entity (e.g., candidate profile, job profile, and so on) from a particular discrete region, for example, discrete region 1210. A set of normalized distances as denoted by integers (e.g., 5, 19, 17, 2, 22, 3) is an example of a hash signature associated with a particular piece of data.

Finally, method 1200 computes a nearest K-similarity with respect to other users in each discrete region. In some embodiments, a discrete region is also referred to as a hash signature, a “hash bucket” or a “hash string.” For example, as shown in FIG. 12, discrete region 2 1212 may be subject to processing functions, where a candidate's pay and corresponding signals (such as annual bonuses and equity) are appropriately reduced to form aggregations. FIG. 12 shows an internal view 1218 of discrete region 1212. In internal view 1218, cross-hatched circles denote jobs or career positions that are not included in an aggregation, while black circles denote jobs or career positions that are included in a computed aggregation 1220.

As an example illustrating how method 1200 functions, parameters included in computing aggregations may include compensation amounts. In some embodiments, compensation amounts may include base pay, annual bonus, annual equity and a one-time signing bonus. Method 1200 may then provide a comparative analysis of salary ranges associated with similar job positions. In some embodiments, this comparative analysis may be presented in a graphical format. In particular embodiments, a parameter that might be included in computing aggregations may be company information, to include a listing of companies where candidates with similar qualifications might be working and also possibly a percentage distribution of the number of candidates over the different associated companies. Information presented may also include revenue sources for the listed companies (e.g., publicly-funded, seed-funded and so on).

Method 1200 may also present results as data associated with job titles that candidates with similar qualifications may have. Example titles may include software engineer, staff data scientist, senior data scientist, data scientist, applied researcher and so on. Other information that may be analyzed and presented includes schools that candidates with similar qualifications attended, for example Carnegie Mellon University, The Ohio State University, University of California, Los Angeles, The Johns Hopkins University, Shanghai Jiao Tong University, Tsinghua University, Peking University and so on. Associated educational degrees may also be presented, to include Bachelor's degrees, Master's degrees or Doctorate degrees. Years of experience of similar candidates might also be presented, possibly in a graphical format, for example, 2-5 years' experience, 5-10 years' experience, 10-20 years' experience, 20+ years' experience and so on. Skill sets associated with similar candidates may also be presented, such as machine learning, algorithms, data mining, Python, C++, Hadoop, Java, computer science, artificial intelligence, MapReduce, R, big data, Matlab, distributed system, pattern recognition, and so on.

Any economic or associated occupational signature computed as discussed herein associated with every job or user enables a decomposition of the economy to the hash signatures (or similarly-defined atomic hash functions) described above. This process helps build a structure of building up profiles of “things”, e.g., companies, titles, educational institutions by the distribution of occupations they employ or are associated with.

In response to a job search for a particular candidate, career data analysis system 100 may return results showing companies that have similar job positions. Information may include a job title, required or desired qualifications (including educational qualifications), typical base salary, annual bonus, annual equity, signing bonus, and so on. Other information presented may include how the candidate may use their existing skill set at a particular job position, as well as new skills the candidate can acquire at that position. Company ranking may also be provided, along with trends as to whether the company rank is rising or falling.

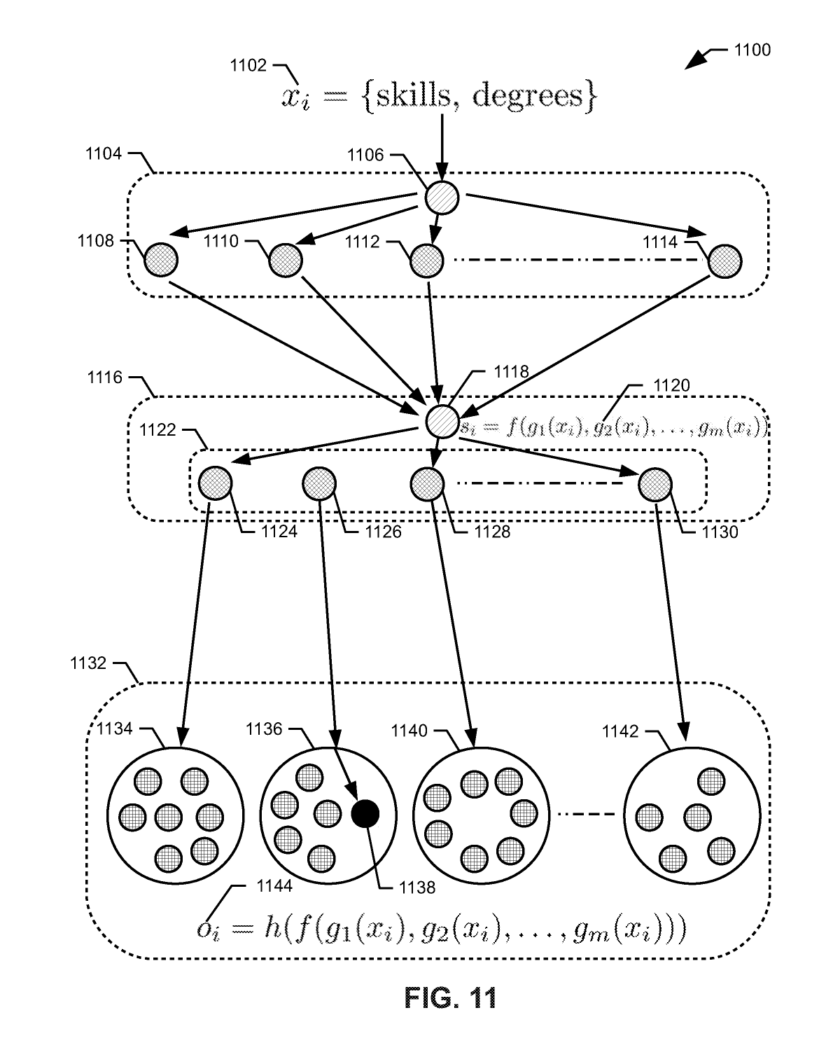

FIG. 13 is a block diagram depicting an embodiment of a system 1300 configured to join disparate data sources. System 1300 may be used as a basis to implement back-end functionality of career data analysis system 100. In some embodiments, a disparate data join engine 1302 receives data from disparate data sources and combines or “joins” this data together. The disparate data sources may include a compensation data source 1304 that is associated with employee compensation for different career positions and qualifications, a people data source 1306 that provides information on candidate career and educational profiles, a jobs data source 1308 that provides data associated with multiple jobs (e.g., required qualifications and skill sets, job duties and so on), a skills data source 1310 that provides data associated with different skill sets associated with different career positions and career tracks, a company data source 1312 that provides company-specific data such as positions offered, compensation amounts, and so on, and a metadata database 1314 that provides metadata associated with different career positions and career tracks, company metadata, resumes, locality signals, and so on.

In some embodiments, disparate data join engine 1302 receives data from the sources described above and joins this data using algorithms such as natural language processing, geometric machine learning, clustering and information retrieval techniques, and other static signal extraction techniques. The output of disparate data join engine 1302 may be mapped to different intersecting datasets, as shown in FIG. 13. For example, a first dataset 1316 may include data associated with jobs, a second dataset 1318 may include data associated with metadata, a third dataset 1320 may include data associated with skill sets, and a fourth dataset 1322 may include data associated with company information. The intersection of these datasets may further correspond to other data categories. For example, the intersection of first dataset 1316, second dataset 1318, third dataset 1320, and fourth dataset 1322 may correspond to a data subset corresponding to data associated with people, and so on. In some embodiments, some combination of intersections of first dataset 1316 through fourth dataset 1322 may include using semantic variations of a company name. For example, a company ABC may have variations or subsidiaries, such as ABC Labs or ABC research. A data corpus associated with these variations may be created by deriving data from, for example, candidate resumes. In particular embodiments, relationships and mappings may be built out across all existing corpuses of data, such as resumes/profiles, jobs, company metadata, and so on. Similar profiles may be built for other attributes such as skills, titles, and university names.

Using disparate data join engine 1302 to render a sparse, multi-dimensional representation of the aggregated, canonicalized data enables the projection of compensation and other signals from one features space into the other via the collective block-structure of relationships in atomic and latent space.

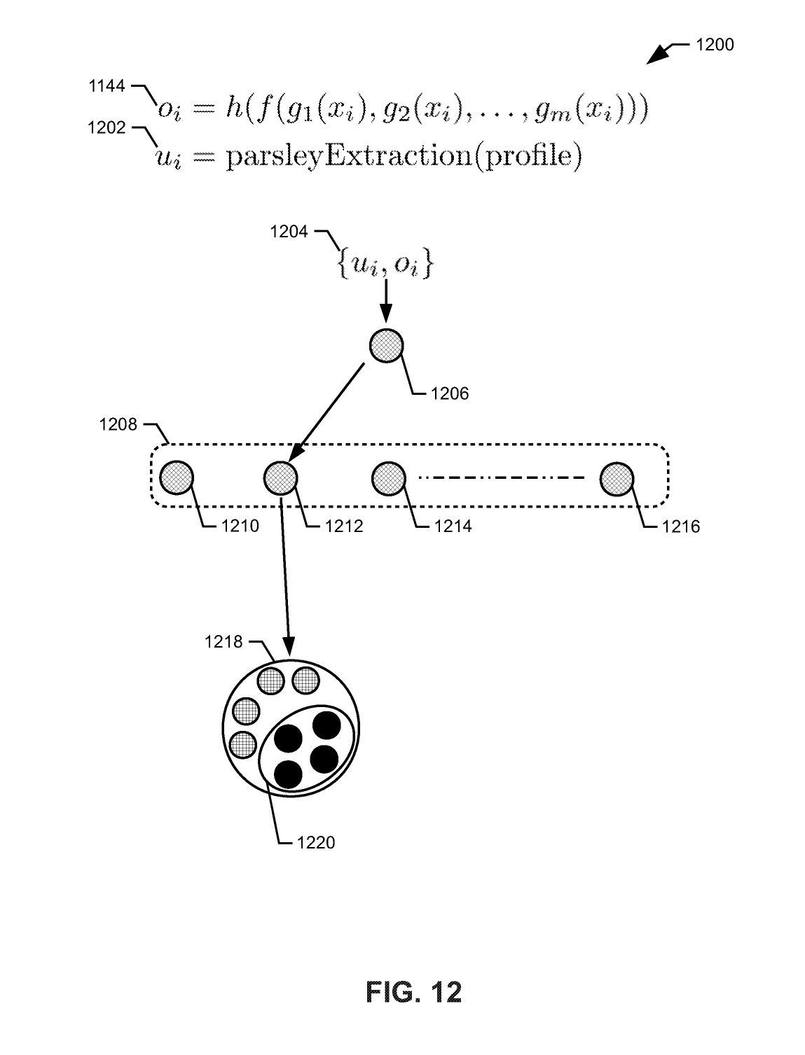

FIG. 14 is a block diagram depicting an embodiment of an artificial intelligence-based job recommendation engine 1400 configured to match a candidate with at least one job. In some embodiments, certain functions associated with artificial intelligence (AI)-based matching of jobs to users (candidates) and users to jobs may be performed by AI job-user matching engine 1008 (FIG. 10) using latent and atomic static and dynamic structures associated with AI job-user matching engine 1008. AI job-user matching engine 1008 may attempt to find substantially the best possible job match for a user based on attainable positions, skills, latent signals, other professionals at jobs, pay, etc.

In some embodiments, artificial intelligence-based recommendation engine 1400 may include a candidate data analysis engine 1414 that includes a job compensation engine 1416 that analyzes data from a candidate profile database 1418 associated with the candidate to determine a job match for the candidate. In some embodiments, job compensation engine 1416 may update data in candidate profile database 1418 based on results of the analysis. In particular embodiments, job compensation engine 1416 uses artificial intelligence algorithms such as genetics algorithms to determine a compensation package for the candidate, where the compensation package is associated with a specific job.

In some embodiments, candidate profile database 1418 may include a skills dataset 1420 that includes data associated with the candidate's skill set (e.g., software programming skills, analytical skills, etc.), a titles dataset 1422 that includes data associated with the candidate's current and past job titles (e.g., lead software engineer, senior scientist, etc.), a likely moves dataset 1424 that may attempt to predict any likely or possible career moves by the candidate, a latent features dataset 1426 that is configured with data associated with latent features, a company dataset 1428 that is includes data associated with the past and present companies that the candidate has worked at, a user signals dataset 1430 that stores any signals generated by the candidate (e.g., job searches, job search results, salary analyses, etc.), an experience dataset 1432 that includes data associated with the candidate's work experience, and a career progression dataset 1434 that is associated with the candidate's spatio-temporal career history. In some embodiments, latent features dataset 1426 and user signals dataset 1430 may include variables that capture a geometric similarity or a geometric economic routing hash signature. Job compensation engine 1416 receives data from all the above datasets and analyzes this data to generate one or more job matches for the candidate.

In some embodiments, artificial intelligence-based recommendation engine 1400 may also include a job data analysis engine 1438 that receives job-related data and analyzes this data to generate a basis for one or more job matches associated with a candidate. In some embodiments, job-related data may be received from a job sources database 1440 that includes a listings and corresponding descriptions of at least one job. In particular embodiments, job-related data may also be received from a sponsored jobs database 1442 that has a similar structure to job sources database 1440, with the main difference being that the job listings and associated descriptions of jobs that related to sponsored jobs database 1442 are sponsored jobs. Data from both job sources database 1440 and sponsored jobs database 1442 is input to a job signal extraction and canonicalization engine 1444 that is configured to perform analysis on job-related data to extract features such as job title, job description, required qualifications, job location, company name, and so on. A job signal dynamics analyzer 1446 receives the output from job signal extraction and canonicalization engine 1444 to determine the dynamical behavior associated with the job signal. Dynamical behavior associated with a job signal may include, for example, the characterization of past trends associated with a career track or job, or any other spatial or temporal dynamic variations associated with the job signal or job data. In some embodiments, dynamical behavior associated with a job signal may include a characterization of company ranking as a function of time, or temporally-occurring fund-raising signals.

In some embodiments, the output of job signal dynamics analyzer 1446 is input to a multi-dimensional structured data search engine 1448 that is configured to generate results in response to a user search request generated either by a client, human resources personnel or some other user of the system. The combination of analyses performed by job data analysis engine 1438 and candidate data analysis engine 1414 may be used to generate one or more job search results or suggestions for a user as illustrated in FIG. 14.

FIG. 14 further illustrates a region 1412 that is associated with the portrayal of job search results. Region 1412 is subdivided into a region 1 1402, a region 2 1404, and a region 3 1406. A user 1408 is located at the center of region 1412. Within each of region 1 1402 through region 3 1406 are jobs associated with search results, with each job being denoted by a crosshatched circle. Based on search result relevance, a job is placed in either region 1, 1402, region 2 1404 or region 3 1406. A relevance line 1410 denotes a decay in relevance of a job in relation to user 1408 in the direction of the line (i.e., away from the user and away from the center of region 1412). In some embodiments, jobs which are of lower relevance to user 1408 are placed in region 1 1402, jobs of medium relevance or medium importance to user 1408 are placed in region 2 1404, while jobs that are most relevant to user 1408 are placed in region 3 1406 by the search results generated by a combination of analyses performed by job data analysis engine 1438 and candidate data analysis engine 1414.

In some embodiments, any user activity associated with user 1408 is used to update data associated with user signals dataset 1430, while data from user signals dataset 1430 may be used to enhance job search results. In particular embodiments, data from likely moves dataset 1424 may be used to map search results to a job listing such as a job listing 1436.

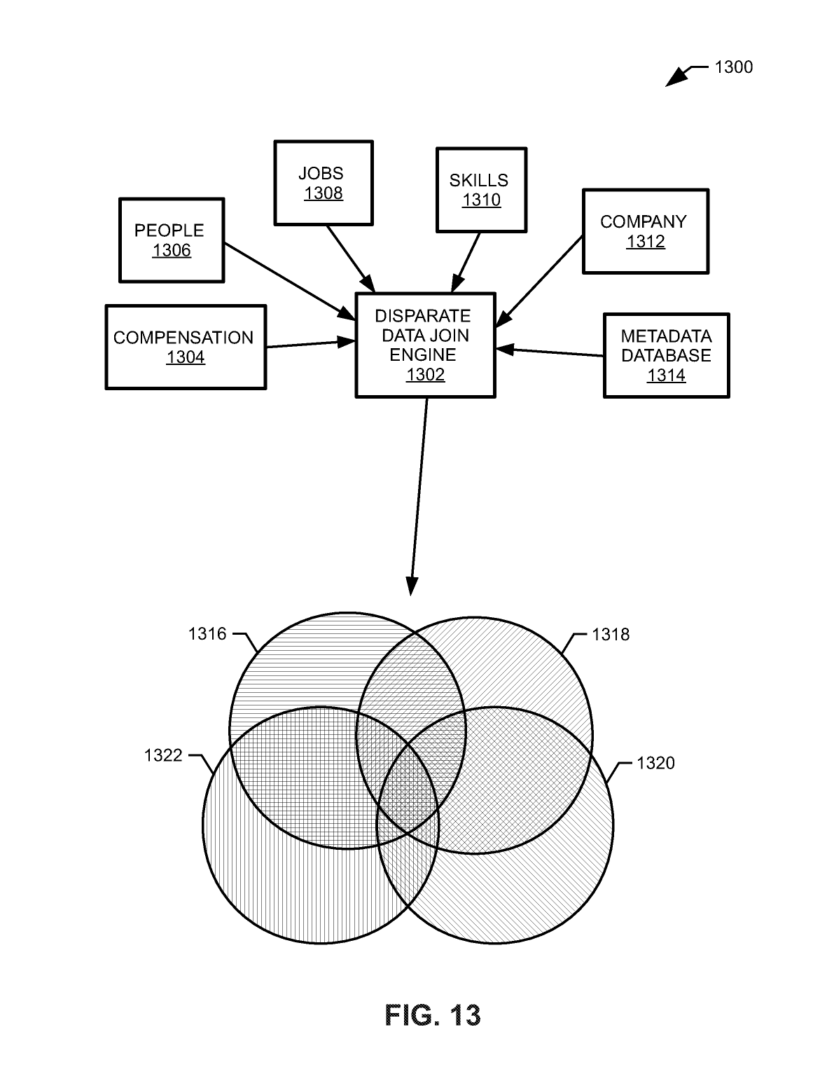

FIG. 15 is a block diagram depicting an embodiment of an artificial intelligence-based skill recommendation engine 1500 configured provide a personalized skill recommendation to a candidate. In some embodiments, artificial intelligence-based skill recommendation engine 1500 includes job data analysis engine 1438 which includes job sources database 1440, sponsored jobs database 1442, job signal extraction and canonicalization engine 1444, and job signal dynamics analyzer 1446. The operations of job data analysis engine 1438 and associated subcomponents are as described above.

In some embodiments, the output of job data analysis engine 1438 is mapped via a mapping 1502 to a plurality of job skill sets, including a job 1 skills 1504, a job 2 skills 1506, through a job N skills 1508. Each of job 1 skills 1504 through job N skills 1508 includes an extracted set of skills associated with the corresponding job or associated skills at each job or represented by professionals at that job in that role. A grouping 1510 is used to characterize the diverse skill sets associated with job 1 skills 1504 through job N skills 1508. In particular embodiments, a grouping 1510 characterizes a spatio-temporal understanding of skill/supply/trending statistics by position type (i.e., skill sets, supply and availability of at least one skill set, or current trends associated with one or more skill sets in the current labor market) associated with job 1 skills 1504 through job N skills 1508. This characterization of a spatio-temporal trend associated with skill/supply/trending statistics allows artificial intelligence-based skill recommendation engine 1500 to compensate for a dynamically-changing labor market.

In some embodiments, grouping 1510 comprises an aggregate set over job 1 skills 1504 through job N skills 1508 that is may be associated with the quality of skills that are associated with a specific company. A quality measure associated with a set of job skills possessed by a candidate at a specific title at a particular company may be different from a quality measure associated with the same set of job skills at another company. Some companies may be specifically associated with highly-ranked quality metrics for certain job skills or certain skill sets. In some embodiments, grouping 1510 may be used to characterize job skills based on such quality metrics. For example, job 1 skills 1504 may be associated with highly-ranked quality metrics for a first company, job 2 skills 1506 may be associated with highly-ranked quality metrics for a second company, and so on.

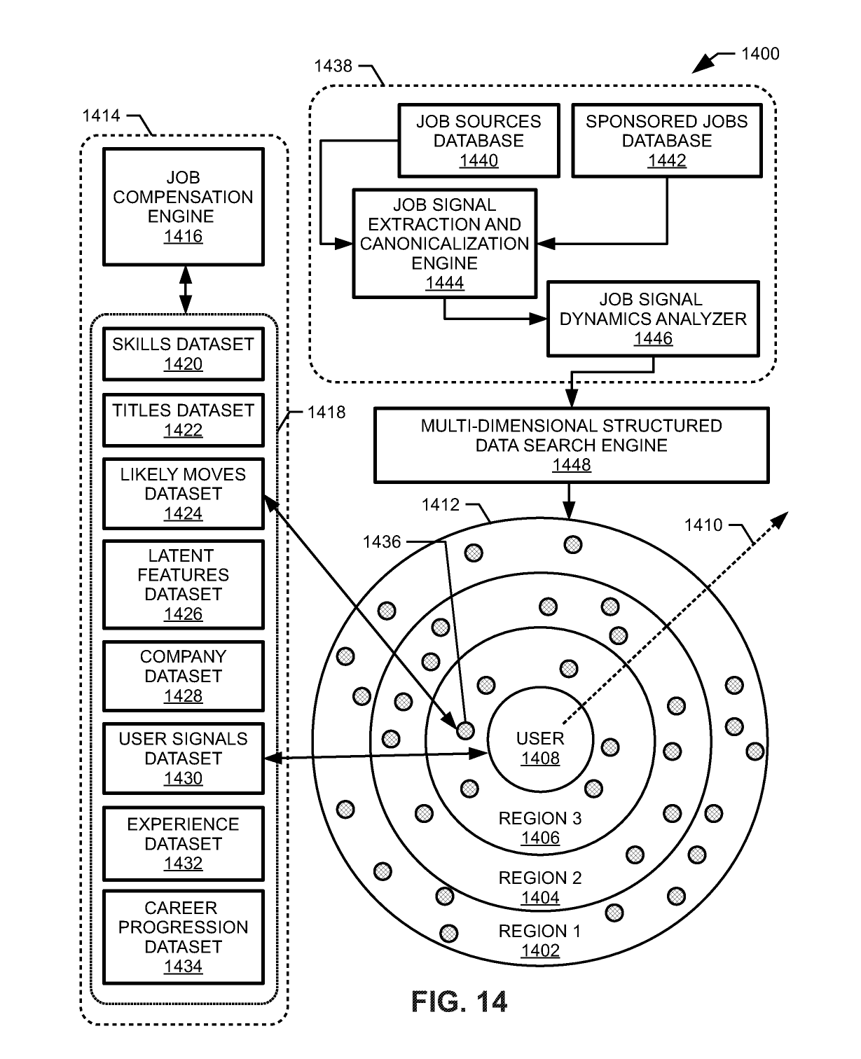

FIG. 16 is a schematic diagram depicting an embodiment of an artificial intelligence-based recommendation engine 1600 configured provide a personalized skill recommendation to a candidate. In some embodiments, a skills grouping 1602 includes one or more skill sets such as a skills that increase job match set 1604, a skills that increase job pay set 1606, a skills that increase future earnings set 1608, and a skills that increase current pay set 1610. The skills associated with each skill set have a certain likelihood of producing an outcome that is characterized by the name of the skill set. In particular embodiments, the intersection of the skill sets indicate better skills to have for a candidate as such a skill has the likelihood of producing multiple favorable outcomes. The skills corresponding to the intersection of all skill sets are the most desirable skills to possess by a candidate as they are associated with favorable likelihood for all favorable outcomes.

In some embodiments, skills grouping 1602 is associated via a mapping 1616 to a time axis 1628 that is further associated with a plot 1618 of a current position and pay variable 1630 associated with an X-axis 1632. In particular embodiments, plot 1618 may depict user parameters 1620 such as a set of attainable job skills 1612 and a set of skills a user has at a kth job 1614.

In some embodiments, a user 1622 is associated with a skill set 1624. Skill set 1624 may be mapped to one or more jobs, as denoted by the crosshatched circles in FIG. 16. Of the one or more jobs, skill set 1624 may be mapped to one or more jobs in a relevant jobs subset 1626 based on career data analysis. In some embodiments, relevant jobs subset 1626 is created based on job recommendations generated by analyzing complementary skills and other parameters that increase a candidate's market salary or other parameters that increase a match to job, earning at new job or fluidity through career.

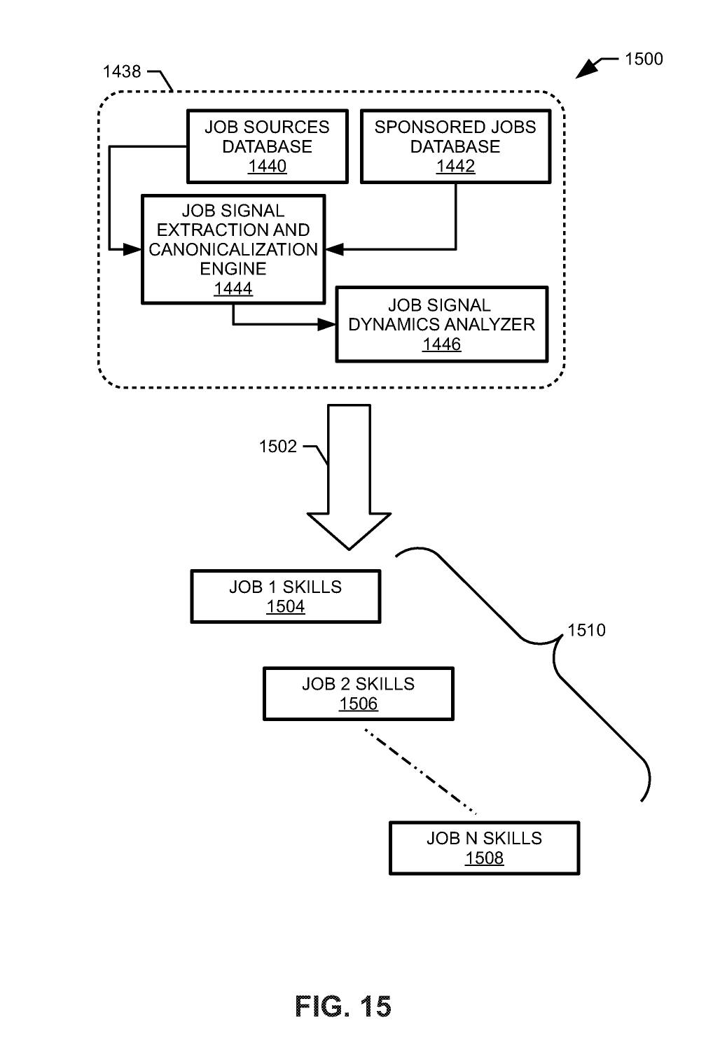

FIG. 17 is a schematic diagram depicting a tree diagram 1700 generated by an embodiment of an artificial intelligence-based reinforcement learning engine configured to determine backwards or forwards feasibility associated with a career path. In some embodiments, tree diagram 1700 shows different possible transitions associated with a candidate's career path, where a transition depicted in tree diagram 1700 might be suggested (or recommended) by a reinforcement learning AI recommendation engine that provides unique projected career paths for a given candidate profile as described herein. Reinforcement learning techniques are based on updating policies, algorithms or actions taken by the reinforcement learning AI recommendation engine based on user interaction and user inputs. In some embodiments, a candidate's professional state 1702 is taken as a starting point, and different options are analyzed and presented to the candidate as potential future projections of an associated career path. A timeline 1706 is used as a temporal reference. Based on timeline 1706 and a starting point at candidate's professional state 1702, different possible career paths are possible. For example, the candidate may take a path that leads to a job 1724 that may not meet the candidate's career goals. Or, the candidate may select a job 1708 along a career path. From job 1708, the candidate may branch out to a job 1714, or to a job 1718. Neither of job 1714 or job 1718 may meet the candidate's career goals. On the other hand, the candidate may progress from job 1708 to a job 1710, and then to a job 1712 which might help meet the candidate's career goals of, for example, maximizing their earnings over a five-year period. The career path from job 1708 to job 1710 to job 1712 might be suggested based on projected earnings, as a path of maximum expected cumulative earnings over a five-year period. In FIG. 17, jobs that help meet one or more of a candidate's career goals are denoted by solid black circles while jobs that might not help meet a candidate's career goal are denoted by crosshatched circles.

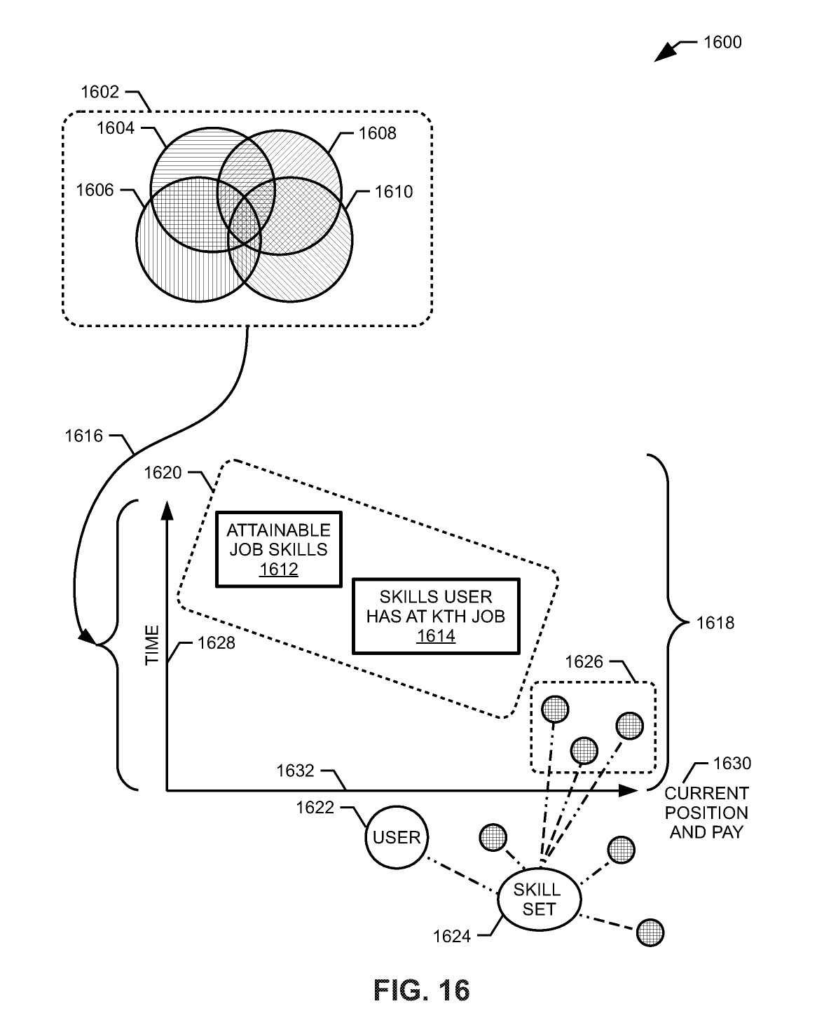

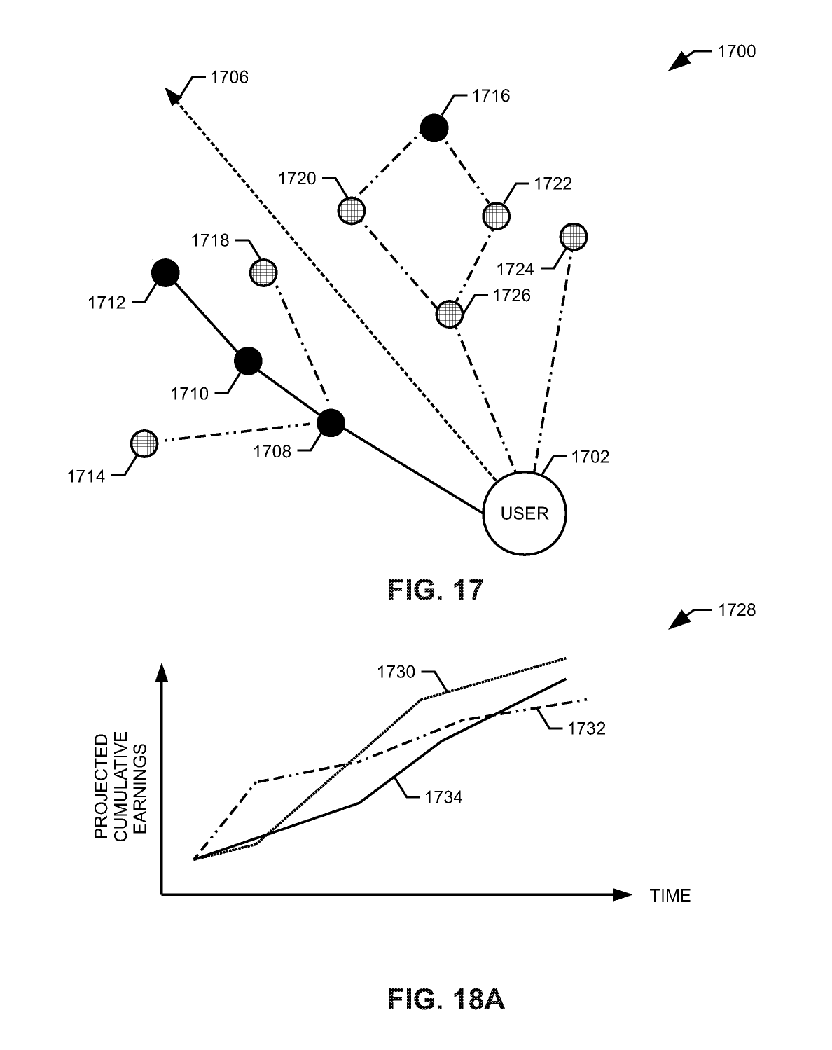

In some embodiments, the path from job 1708 to job 1710 and then to job 1712 might be suggested by a reinforcement learning AI recommendation engine that provides unique projected career paths for a given candidate profile. In particular embodiments, a candidate might want to acquire a certain career state in terms of job title or position. In that case, artificial intelligence-based reinforcement learning engine may suggest a career path along a job 1726, a job 1720, to culminate in the candidate's goal at a job 1716. In some embodiments, the reinforcement learning AI recommendation engine may suggest an alternative career path from job 1726, to a job 1722, to a final goal of job 1716. For example, a candidate may want a position as a senior director of engineering within a period of five years. The AI recommendation engine can thus recommend multiple options that increase the likelihood of the candidate achieving their goal in the desired timeframe. A particular embodiment of an artificial intelligence-based reinforcement learning engine that is configured to analyze career data and generate the results similar to those depicted as tree diagram 1700 is described in FIG. 18B.

FIG. 18A is a graphical representation of results 1728 that may be presented by an embodiment of an artificial intelligence-based recommendation engine such as artificial intelligence-based recommendation engine 1400. In some embodiments, results for the artificial intelligence (AI)-based recommendation engine may be presented in graphical format as shown in graphical representation 1728 that plots projected cumulative earnings versus time. For example, three different scenarios (also known as “paths” or “policies”) may be presented such as a first path 1730, a second path 1732 and a third path 1734. Each of these paths depicts a projected path or action that is designed to maximize cumulative earnings over a desired finite time horizon.

FIG. 18B is a block diagram depicting an embodiment of an artificial intelligence-based reinforcement learning engine 1800 that is configured to determine backwards or forwards feasibility associated with a career path. In some embodiments, artificial intelligence-based reinforcement learning engine 1800 includes a career engine 1802. In particular embodiments, career engine 1802 is configured to determine, for example, promotion paths, estimate an approximate time for a candidate to achieve a particular career goal, the expected earnings along a career progression path, suggested skills for a candidate to develop along a career path, and so on. Career engine 1802 may be coupled to a forwards feasibility analyzer 1804 that is configured to compute the feasibility of paths going forward in time, or paths leading from a candidate's current state to one or more projected future states. Forwards feasibility computations may include earnings and time likelihoods, while attempting to determine different potential paths a candidate can traverse, what the expected earnings might be, the time period it would take to achieve a particular goal, and the likelihood of achieving a set of career goals.

In some embodiments, career engine 1802 is coupled to a backwards feasibility analyzer 1806 that is configured to compute, given a candidate's starting point along a career path and a desired goal along the career path, all feasible paths in a backwards direction from the desired goal to the starting point along the career path. Backwards feasibility analyzer 1806 is also configured to fully characterize these feasible paths. Backwards feasibility computations may include earnings and time likelihoods, while attempting to determine different potential paths a candidate can traverse, what the expected earnings might be, the time period it would take to achieve a particular goal, and the likelihood of achieving a set of career goals. In particular embodiments, forwards feasibility analyzer 1804 may be coupled to backwards feasibility analyzer 1806. Forwards feasibility analyzer 1804 and backwards feasibility analyzer 1806 together implement a set of progressive and regressive temporal data analysis functions.

In some embodiments, forwards feasibility analyzer 1804 and backwards feasibility analyzer 1806 may be individually coupled to an artificial intelligence skill recommendation engine 1814. In some embodiments, artificial intelligence skill recommendation engine 1814 may implement one or more function implementation engines such as a first function implementation engine 1808 that is configured to compute how many months a transition would take for a given user and a current state. In some embodiments, the computed transition is associated with transitioning from, for example, the candidate's professional state 1702 to job 1708 and so on.

In some embodiments, artificial intelligence skill recommendation engine 1814 may include a second function implementation engine 1810 configured to quantify a probability of transitioning from a title to a new position for a given user (candidate). Artificial intelligence skill recommendation engine 1814 may also include a third function implementation engine 1812 that computes the earnings of each user (candidate) that are unique to each user, at every position in, for example, tree diagram 1700. A feedback loop 1816 associated with artificial intelligence skill recommendation engine 1814 symbolizes the reinforcement learning nature of the system.

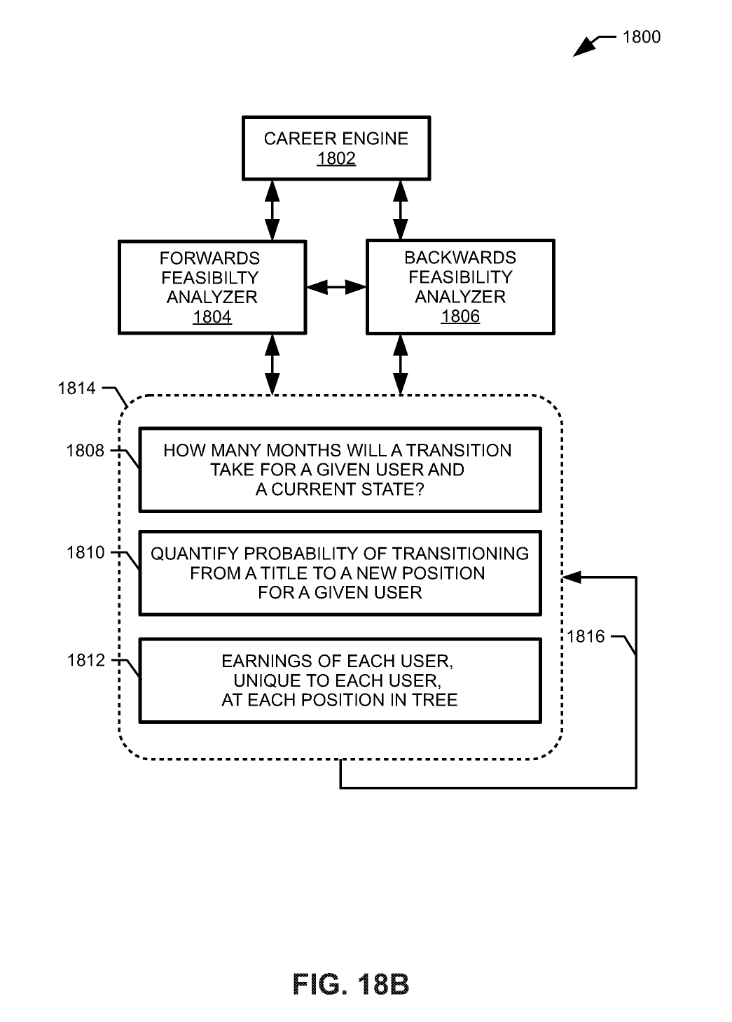

FIG. 19 is a block diagram depicting an embodiment of a static signal extraction system 1900 configured to extract a static genome signal from received data. In some embodiments, static signal extraction system 1900 may include a static genome signal extraction engine 1902 that is configured to process career data and output a static genome signal 1914. Static signal extraction system 1900 system may include algorithms that perform machine learning clustering of career data, and may perform natural language processing to canonicalize different attributes, e.g., company names, university names, skills, etc. In some embodiments, the process of canonicalization can be viewed as a data normalization process, where one or more keywords signifying a particular entity are mapped to that entity. For example, the terms “University of Michigan, Ann Arbor,” “UM Ann Arbor,” “umich,” etc., when referenced, individually map to the canonicalized data entity “University of Michigan, Ann Arbor.”

In some embodiments, static genome signal extraction engine 1902 may include a company attributes retrieval and canonicalization engine 1904 that is configured to retrieve company attributes and canonicalize these attributes. In some embodiments, company attributes retrieval and canonicalization engine 1904 is configured to use adjacent signals to update the relevance signal of the most likely nomenclature of an object (for example, the University of Michigan, Ann Arbor example described above). In particular embodiments, machine learning may be used to project semantic signals into a geometric space where the semantic signals can be mapped to the appropriate entity (e.g., University of Michigan, Ann Arbor).

In some embodiments, static genome signal extraction engine 1902 may also include a title/position attributes retrieval, canonicalization manager 1906 that is configured to retrieve attributes associated with a specific position or title and canonicalize these attributes. In some embodiments, the attributes associated with a specific position or title may include a job description, expected qualifications, desired skills and so on.

In some embodiments, static genome signal extraction engine 1902 may also include a locality attributes retrieval engine 1908 that is configured to retrieve and canonicalize data associated with a specific geographic region. For example, a search for “Berkeley, Calif.” returns geographic data, including latitude/longitude, geo hash data, the canonical name of the associated city, and so on. In particular embodiments, locality attributes retrieval engine 1908 may also retrieve and canonicalize data associated with local demand and supply related to the existing local job market. In some embodiments, static genome signal extraction engine 1902 may include a people attributes retrieval engine 1910 that is configured to retrieve attributes associated with distribution of signals of professionals in a particular company at a particular role (i.e., job position or title). Static genome signal extraction engine 1902 may also include latent attribute extraction, clustering and formation engine 1912 that is configured to extract latent features from career data. For example, latent attribute extraction, clustering and formation engine 1912 may analyze a comprehensive list of companies and form a functional distribution of the economic signature of the workforce associated with each company. Latent attribute extraction, clustering and formation engine 1912 may then cluster these signatures and then obtain a notion of “like” companies: basing a job position analysis on who each company hires tends to be good signal for who they compete with. When a search is run, a company query receives this data as results, and such retrieved (geometric) data is used by matching and pricing algorithms.

In some embodiments, a job signal processor 1918 receives a raw job profile from a raw job profile dataset 1916. A raw job profile may include basic information about a job or position, such as job description, job location, required qualifications, and so on. Job signal processor 1918 performs functions on the raw job profile and prepares the signal for processing by static genome signal extraction engine 1902. In some embodiments, a canonical job signal extractor 1920 receives raw job profile data from job signal processor 1918 and extracts, for example, skills, degrees, and years of experience from raw profile using machine learning algorithms, natural language processing, and information retrieval (IR). Data from job signal processor 1918 is input to static genome signal extraction engine 1902.

In some embodiments, a user signal processor 1924 receives a raw user profile from a raw user profile dataset 1922. In some embodiments the raw user profile may include a candidate's career history, educational history, job title history, and so on. User signal processor 1924 is configured to process the raw user profile and prepare the signal for processing by static genome signal extraction engine 1902. In some embodiments, a university attribute retriever 1926 is configured to receive the raw user profile from user signal processor 1924 and extract, for example, attributes associated with the candidate's educational history to include university information. University attribute retriever 1926 may also be configured to canonicalize data and perform latent feature formation as an output signal. In particular embodiments, the output of university attribute retriever 1926 is received by a latent signal extractor 1928, where latent signal extractor 1928 is configured to extract latent data from the output of university attribute retriever 1926, where the latent data includes career movement, quality of institutions, risk profile, demographics, etc.

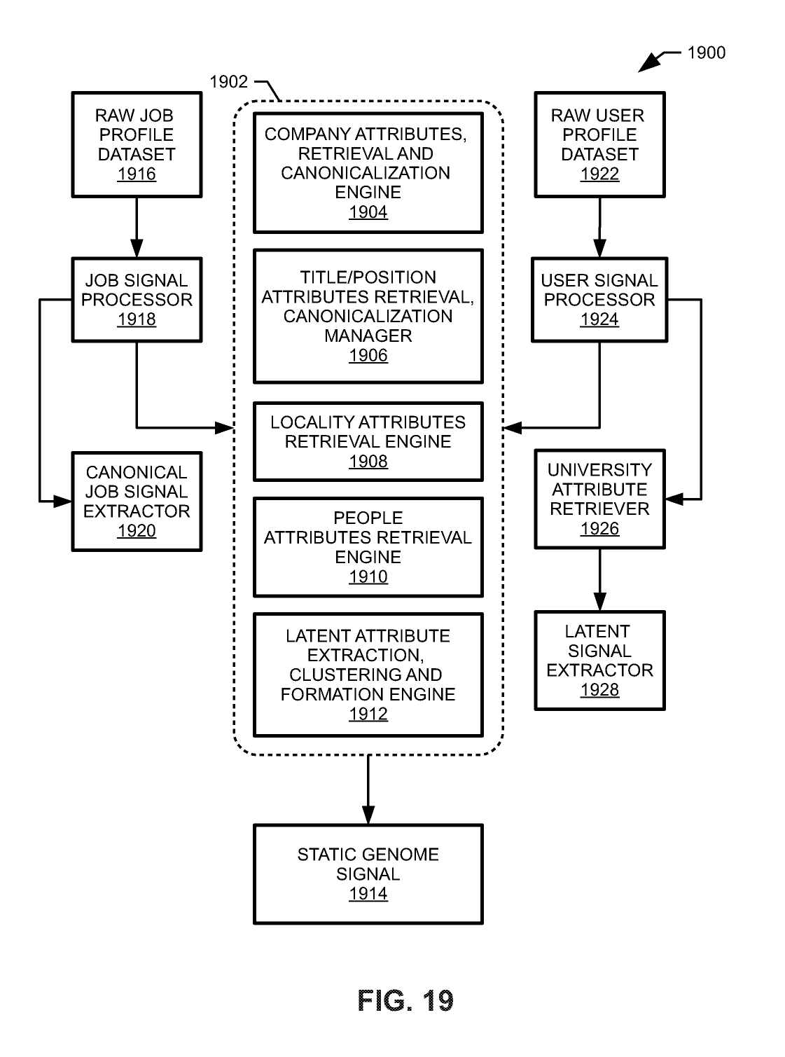

FIG. 20 is a block diagram depicting an embodiment of a labor market transition dynamics signal extraction system 2000 configured to perform signal extraction of transition dynamics associated with a labor market. In some embodiments, labor market transition dynamics signal extraction system 2000 is configured to perform signal extraction of the transition dynamics of a labor market in atomic and latent form. In some embodiments, labor market transition dynamics signal extraction system 2000 may implement machine learning and statistical techniques to understand how the most granular of elements of the labor market evolve forwards/backwards in time and “space” (i.e., over things). In particular embodiments, labor market transition dynamics signal extraction system 2000 includes a statistical methods system 2004 that is configured to receive and process a collection of static genome signals from a professional cluster 2002. In some embodiments, collection of static genome signals from a professional cluster 2002 may include a collection of data across professionals and associated static-derived genome signals via a static signal extraction service.

In some embodiments, statistical methods system 2004 may be configured to generate static latent/atomic Signals of how different “coordinates”, e.g., skills, titles, evolve forwards and backwards in time, with respect to their probabilities. To accomplish this task, statistical methods system 2004 may include a forwards or backwards progression of complementary skill acquisition computing engine 2006 that is configured to compute temporal progressions or regressions associated with complementary skill acquisition. In some embodiments, forwards or backwards progression of complementary skill acquisition computing engine 2006 may perform progressive or regressive temporal analysis on associated data. In some embodiments, statistical methods system 2004 may include a forwards or backwards progression of advance or departure computing engine 2008 that is configured to determine any progression or advance made by a candidate in a company, or if the candidate exits the company. Backwards progression techniques may be used for reverse-mapping trend analysis as discussed earlier.

In some embodiments, statistical methods system 2004 may also include a forwards or backwards progression of talent flow computing engine 2010 that is configured to analyze a flow of talent into and out of company and company types. In some embodiments, forwards or backwards progression of talent flow computing engine 2010 may perform temporal analyses on data, with backwards progression techniques being used for reverse-mapping trend analysis as discussed earlier. In particular embodiments, statistical methods system 2004 may include a movement of like professionals manager 2012 that is configured to determine career paths followed by career professionals in similar professions in atomic and latent features by using techniques such as spectral methods and geometric hashing.

In some embodiments, statistical methods system 2004 may include a career progression within a company inference engine 2014 that is configured to analyze career data to determine how one or more professionals progress within a particular company with respect to their individual career paths. In particular embodiments, statistical methods system 2004 may include a university professionals manager 2016 that is configured to determine a forward progression of university graduates along their respective career paths, to include choice of career and company type by the university graduates. In particular embodiments, statistical methods system 2004 may include a geographic migration pattern manager 2018 that is configured to perform temporal progressive and regressive analysis of data to characterize the flow and migration of candidates with similar careers into and out of specific geographic regions.

In some embodiments, statistical methods system 2004 may be coupled to a dynamics analysis engine 2020 that is configured to receive results from statistical methods system 2004 and perform analysis of the dynamics associated with the results. In some embodiments, dynamics analysis engine 2020 may include a spatio-temporal dynamics engine 2022 that is configured to implement machine learning models to predict, for example, time to quit, time to promotion, time to lateral move, and so on, as well as probabilities over these fields. Dynamics analysis engine 2020 may also include a career flow manager 2024 that is configured to analyze how people move within a company, e.g., roles, over time, earnings, etc. in a company, how people move to a new company, and so on. Results from career flow manager 2024 may be personalized to a specific candidate or more generalized to present a more general trend. In particular embodiments, dynamics analysis engine 2020 may produce results that are personalized to specific candidate at a position or more general results that are agnostic to a specific candidate and personalized to all employees in a specific position.

Results generated by dynamic analysis engine 2020 may be output to a collection of dynamic genome signals across singlet and joint coordinates 2026. Collection of dynamic genome signals across singlet and joint coordinates 2026 is the final output of the system and completes the process of signal extraction of the transition dynamics of the labor market in atomic and latent form.

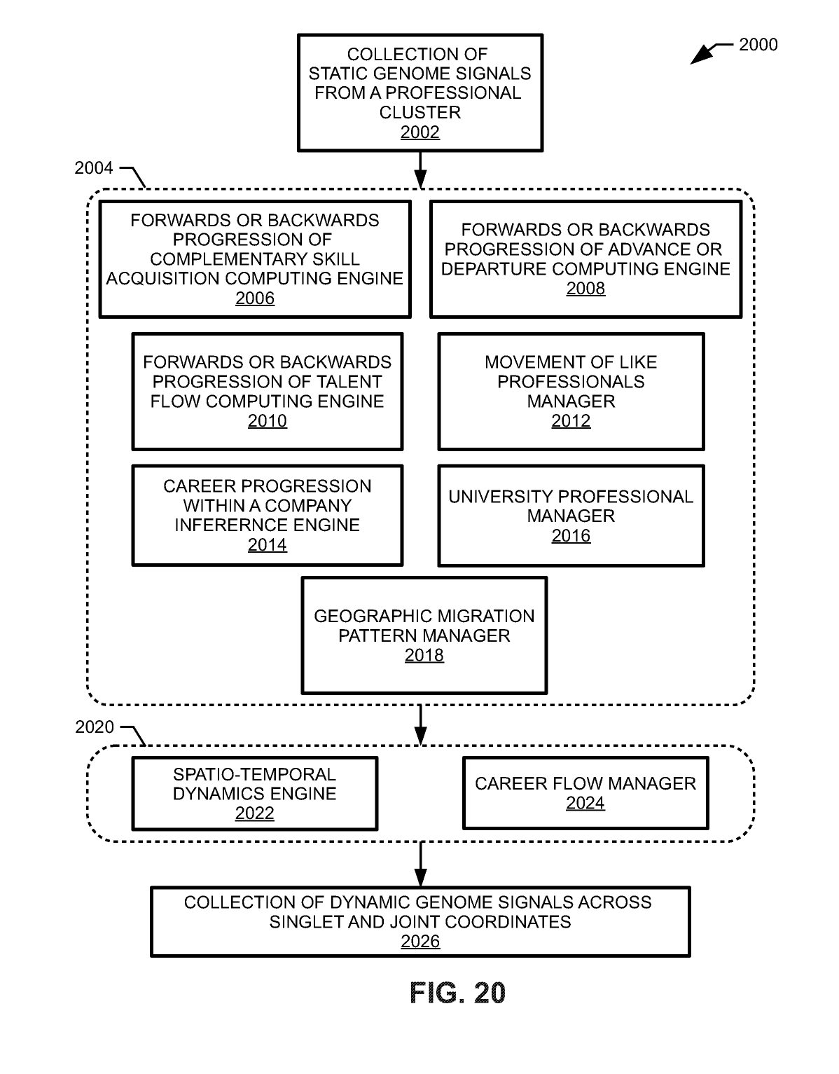

FIG. 21 is a flow diagram depicting an embodiment of a method 2100 to generate customized compensation information for an individual or job. In some embodiments, method 2100 includes statistical functional estimation methods that can “value” the compensation of a professional, student, or a job itself based on the input signals extracted from career data to generate customized compensation information, a suggested salary, or a salary recommendation.

In some embodiments, at 2102, the method receives an input genome signal where the input genome signal may be generated, for example, as a static genome signal by static genome signal extraction engine 1902 or as a dynamic genome signal generated by dynamic analysis engine 2020. In some embodiments, the input genome signal is generated by processing career data associated with a candidate. At 2104, the method determines whether the candidate is a student. If the candidate is not a student then the method continues to 2106, where the method receives similar titles via spectral clustering. In some embodiments, the receiving of similar titles via spectral clustering may include data associated with similar job titles; this step is performed to smooth over and account for human-entered semantic variations to provide a more consistent set of data. Next, at 2108, the method runs a Bayesian sampling engine. In some embodiments, the Bayesian sampling engine is run over similar job titles. In particular embodiments, results from running the Bayesian sampling engine may be cached against an existing structure and each result may be stored. Next, at 2114 the method projects the user (candidate) onto an appropriate subspace.

If, at 2104, the method determines that the candidate is a student, then the method continues to 2110, where the method forms a user Bayesian posterior over job-related features and samples from this distribution. Next, at 2112, the method runs a Bayesian sampling engine. In some embodiments, the Bayesian sampling engine is run over job-related features. An example of job-related features as characterized in a data structure that can be read by the Bayesian sampling engine is:

{‘time_in_workforce’: [5, None], ‘title’: u‘Software Engineer’, ‘skills’: [u‘Debugging’, u‘C’, u‘Java’, u‘Neural Networks’, u‘Software Engineering’, u‘Open Source’, u‘Python’, u‘Deep Learning’, u‘Processing’, u‘C++’, u‘Machine Learning’, u‘Speech Recognition’, u‘Lua’, u‘Algorithms’, u‘Architectures’, u‘GPU’, u‘REST’, u‘Software’, u‘Distributed Systems’, u‘Computer Science’], ‘company’: u‘Facebook’, ‘degrees’: [‘BS’, ‘MS’], ‘_raw’: {‘company’: ‘Facebook’, ‘title’: ‘Applied Research Scientist and Software Engineer, Speech and Machine Learning’}, ‘locality_geohash_prefix’: ‘9q’, ‘company_specific_title’: u‘Software Engineer’, ‘locality_ghash3’: ‘9q9’}

The above example captures job-related features such as the time a candidate has been in a workforce, the job titles associated with the candidate, the skillset associated with the candidate, any companies the candidate might have worked for, the university degrees earned by the candidate, and so on.

In some embodiments, results from running the Bayesian sampling engine may be cached against an existing structure and each result may be stored. The method then proceeds to 2114, where the method projects the user (candidate) onto an appropriate subspace. Next, the method continues to 2116, where the method clusters the user or retrieves non-parametric compensation density estimation and user's compensation predictions. This step is essentially a projection step that is performed based on the analysis of current and past career data. At 2118, the method performs a Bayesian mixture aggregation to provide a compensation response. This compensation response is then converted into a user or job compensation response at final step 2120, providing customized compensation information for an individual or a job.

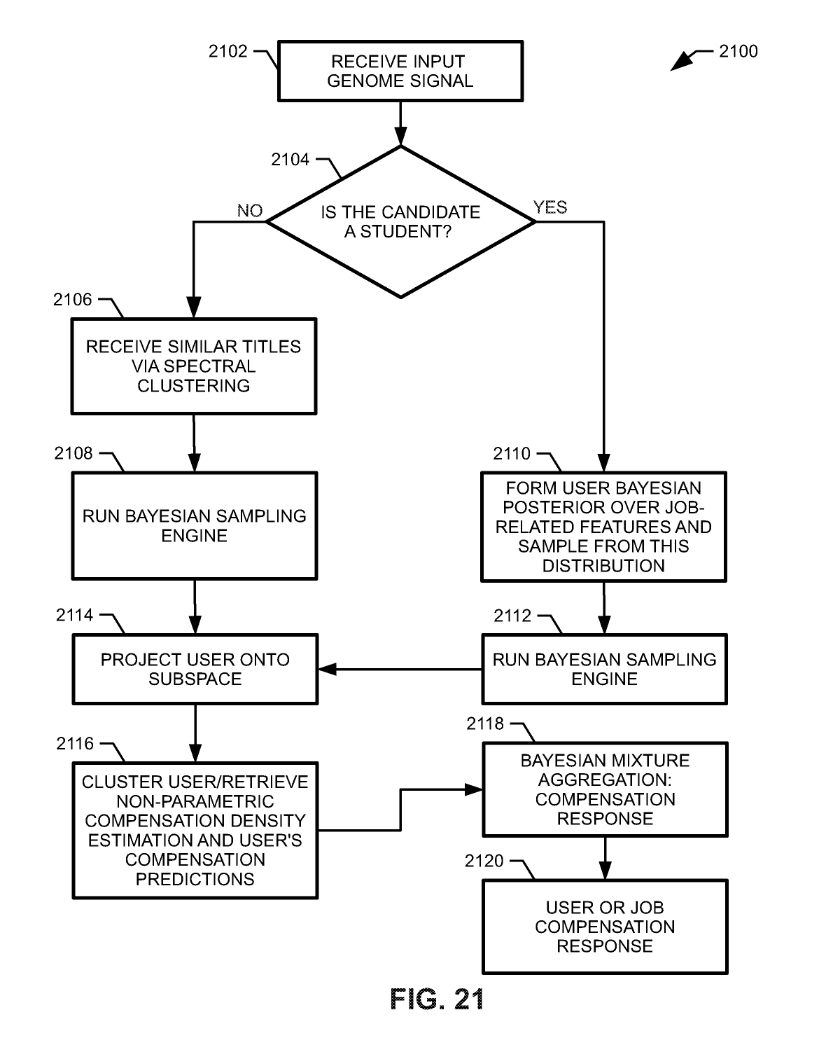

FIG. 22 is a schematic diagram depicting an embodiment of an algorithm 2200 configured to generate a company rank. In some embodiments, a company rank is generated based on talent flux—the entrance or departure of employees—associated with the company. In some embodiments, algorithm 2200 begins as a function COMPANYRANK( ) at 2202 that is configured to receive career data in the form of a variable Data_{0:k}_{ₘₐₓ}, where k is a time index variable and kₘₐₓ is a maximum value associated with time index k. At step 2204, time index variable k is initialized to zero. Next, at step 2206, a uniform probability distribution is initialized:

$${p}_{k} = \frac{1}{n}$$

At next step 2208, a return object associated with algorithm 2200 is initialized as a return set P, where set P is initialized as an empty set. Next, at 2210, a while( ) loop is initiated that iterates while k is less than kₘₐₓ. At 2212, k is incremented by 1, while at 2214 a maximum likelihood fit flux matrix Ĥ_{0:k} updated as:

Ĥ_{0:k}→maxLikelihood(Data_{0:k})

Next, at 2216, an eigenvalue problem is solved, denoted by:

\hat{p}ₖ→solve([I−Ĥ_{0:k}]pₖ=0)

At 2218, return set P is updated to include the most recent estimate \hat{p}ₖ:

P→P U\hat{p}ₖ

At 2220, the while( ) loop ends—a check is made to see if k is less than kₘₐₓ. If k is less than kₘₐₓ, then algorithm 2200 returns back to 2210. If k is not less than kₘₐₓ then algorithm 2200 returns return set P at 2222, and algorithm 2200 ends at 2224 via an end function command.

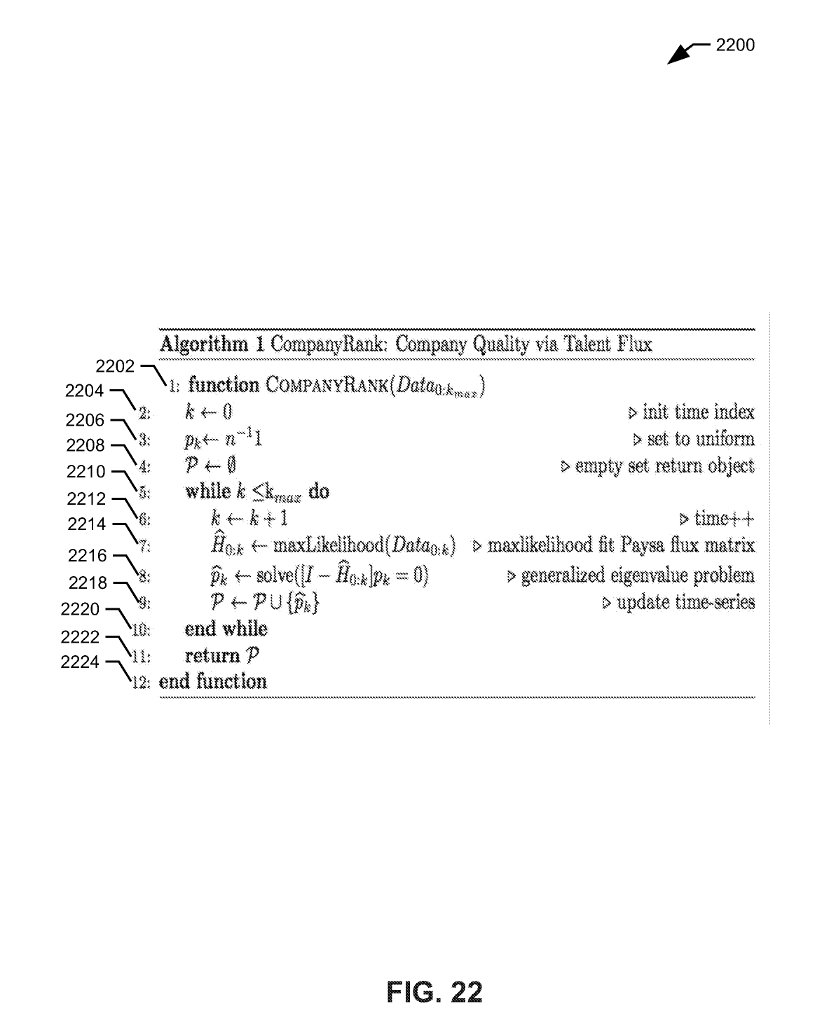

FIG. 23 is a block diagram depicting an embodiment of a career data analysis system 2300. In some embodiments, career data analysis system 2300 may include a career management engine 2302 that is configured to provide career navigation suggestions to a candidate. Career management engine 2302 is configured to determine career navigation (e.g., career paths for a candidate), while also computing substantially optimal policies for earnings, goal achievement, career direction (path), and so on. In some embodiments, career data analysis system 2300 may include a skill development engine 2304 that is configured to determine and suggest to a candidate one or more important skills that the candidate may not currently possess. These skills may help increase the candidate's value in the job market over a span of their career.

In some embodiments, career data analysis system 2300 may include a geometric search index manager 2306 that is configured to determine job/candidate matching, like users (i.e., like professionals), and so on. In particular embodiments, geometric search index manager 2306 may be configured to generate hash signatures associated with a particular job profile or candidate profile. Career data analysis system 2300 may also include a maximum likelihood pricing engine 2308 that computes maximum likelihood estimates associated with a value associated with a job, an employee, an offer, and so on. In some embodiments, maximum likelihood estimates may include a conditional mean and an associated variance corresponding to a log normal probability density function.

In some embodiments, career data analysis system 2300 may include a conditional signal extraction manager 2310 that refines any signals (or data) conditioned on industry or occupation hashing, over both spatial and temporal domains. Career data analysis system 2300 may also include a routing layer 2312 that is configured to detect industries and occupations by constructing geometric hash signatures that capture any variations in data associated with different industries or occupations.

In some embodiments, career data analysis system 2300 may include a signal extraction manager 2314 that is configured to generate a high-dimensional, sparse, multi-dimensional map that captures underlying data embedded in a structured document or raw text (e.g., a candidate's resume or a job description).

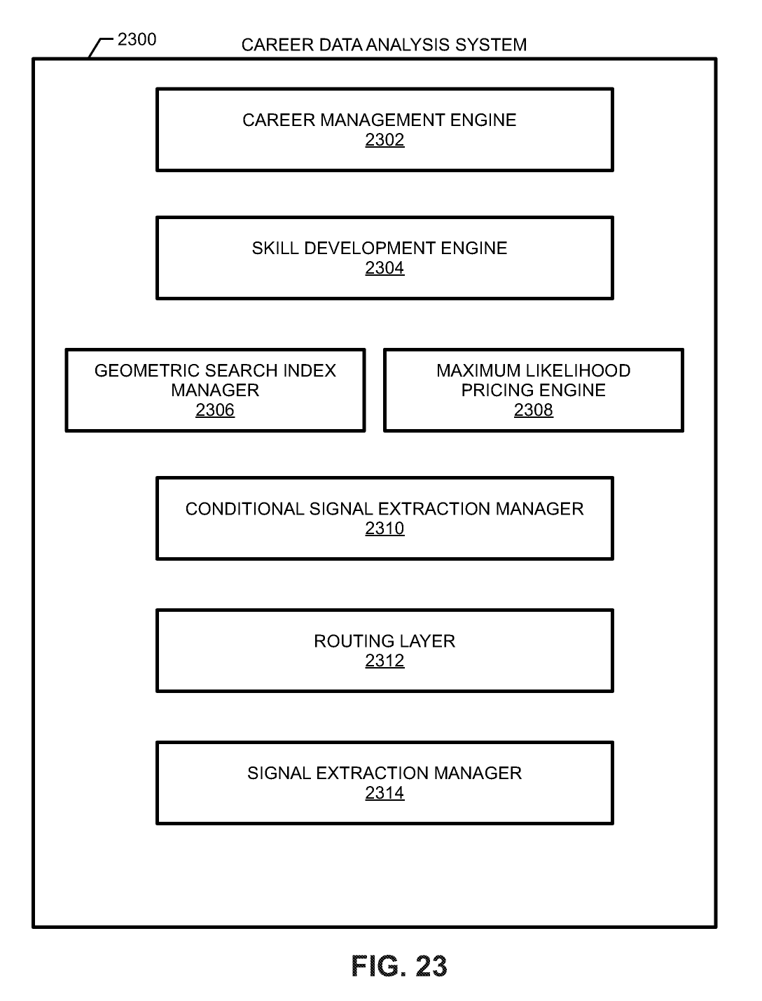

FIG. 24 is a schematic diagram depicting a user interface 2400 as presented by an embodiment of career data analysis system 100. In some embodiments, user interface 2400 displays results of a job search as requested by a candidate. Career data analysis system 100 analyzes the candidate profile and presents relevant, matching jobs to the candidate. User interface 2400 displays a single job listing. In some embodiments, user interface 2400 may display multiple job listings, with each job listing having a similar structure to the single job listing displayed by user interface 2400 in FIG. 24.

In some embodiments, user interface 2400 displays a company name indicator 2402 that displays the name of a company associated with a particular job listing. In FIG. 24, company name indicator 2402 displays “Company ABC.” In other instances, company name indicator 2402 may display other company names depending on the results of the analysis performed by career data analysis system 100. In some embodiments, user interface 2400 displays a job title 2404. In FIG. 24, job title 2404 as displayed by user interface 2400 is of a Senior Data Scientist. Other job matches may result in a different job title being displayed (e.g., one of nurse practitioner, physician assistant, accountant, research engineer, and so on).

In some embodiments, user interface 2400 displays a compensation data panel 2408 associated with job title 2404. FIG. 24 shows compensation data panel 2408 describing a candidate's market salary of $315,000 based on a base salary of $184,000, an annual bonus of $31,000, an annual equity of $77,000, and a signing bonus of $23,000. In some embodiments, user interface 2400 displays company trending information 2406. In FIG. 24, company trending information 2406 suggests that Company ABC is trending down in company rank, based on company ranking analysis performed by career data analysis system 100.

In some embodiments, user interface 2400 displays a job data panel 2410 that includes information on how the candidate's profile matches the job. In some embodiments, job data panel 2410 also displays information regarding whether the job is a realistic move for the candidate. In particular embodiments, job data panel 2410 displays skills that the candidate can leverage at the job. Job data panel 2410 in FIG. 24 displays skills including Hadoop, computer science, algorithms, machine learning, python, software development, and more.

In some embodiments, job data panel 2410 displays valuable new skills that the candidate can learn on the job, such as C++, deep learning, Apache Spark, user experience, automation, C, and more. Job data panel 2410 may also display other relevant job related data such as the candidate's experience (5 to 10 years), and the candidate's educational degree (Ph.D.).

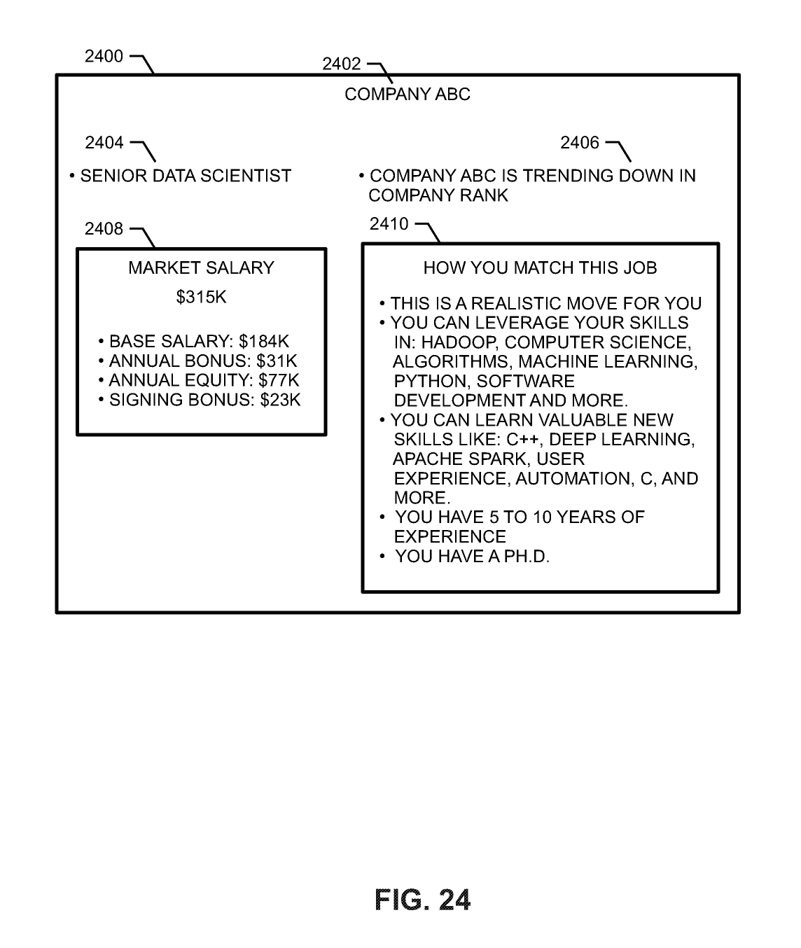

FIG. 25 is a schematic diagram depicting presentations of recommended skills 2500 as determined by an embodiment of career data analysis system 100. FIG. 25 illustrates a region 2506 that is associated with the presentation of recommended skills. Region 2506 is subdivided into a region 1 2508, a region 2 2510, and a region 3 2512. A user 2502 is located at the center of region 2506. Within each of region 1 2508 through region 3 2512 are jobs, skills and nearest professionals associated with search results. In FIG. 25, a job is represented by a crosshatched circle, a skill is represented by a circle with diagonal hatching, and a nearest professional is represented by a solid circle. Based on search result relevance, a job, a skill or a nearest professional is placed in either region 1, 2508, region 2 2510 or region 3 2512. A relevance line 2504 denotes a decay in relevance of a job, a skill or a nearest professional in relation to user 2502 in the direction of the line (i.e., away from the user and away from the center of region 2506). In some embodiments, a nearest professional is defined as a professional having a similar profile as the candidate based on any combination of job title, educational qualifications, skill set, career path, and so on.

In some embodiments, jobs which are of lower relevance to user 2502 are placed in region 1 2508, jobs of medium relevance or medium importance to user 2502 are placed in region 2 2510, while jobs that are most relevant to user 2502 are placed in region 3 2512 by the search results generated by career data analysis system 100.

In some embodiments, skills which are of lower relevance to user 2502 are placed in region 1 2508, skills of medium relevance or medium importance to user 2502 are placed in region 2 2510, while skills that are most relevant to user 2502 are placed in region 3 2512 by the search results generated by career data analysis system 100.

In some embodiments, nearest professionals which are of lower relevance to user 2502 are placed in region 1 2508, nearest professionals of medium relevance or medium importance to user 2502 are placed in region 2 2510, while nearest professionals that are most relevant to user 2502 are placed in region 3 2512 by the search results generated by career data analysis system 100.

A goal of the presentations of recommended skills 2500 is to show a user:
Any skills expected by the labor market from the candidate based on the candidate's qualifications.
Any skills possessed by nearest professionals that the candidate might not have.
Any skills that are the most incrementally valuable from the perspective of career advancement.

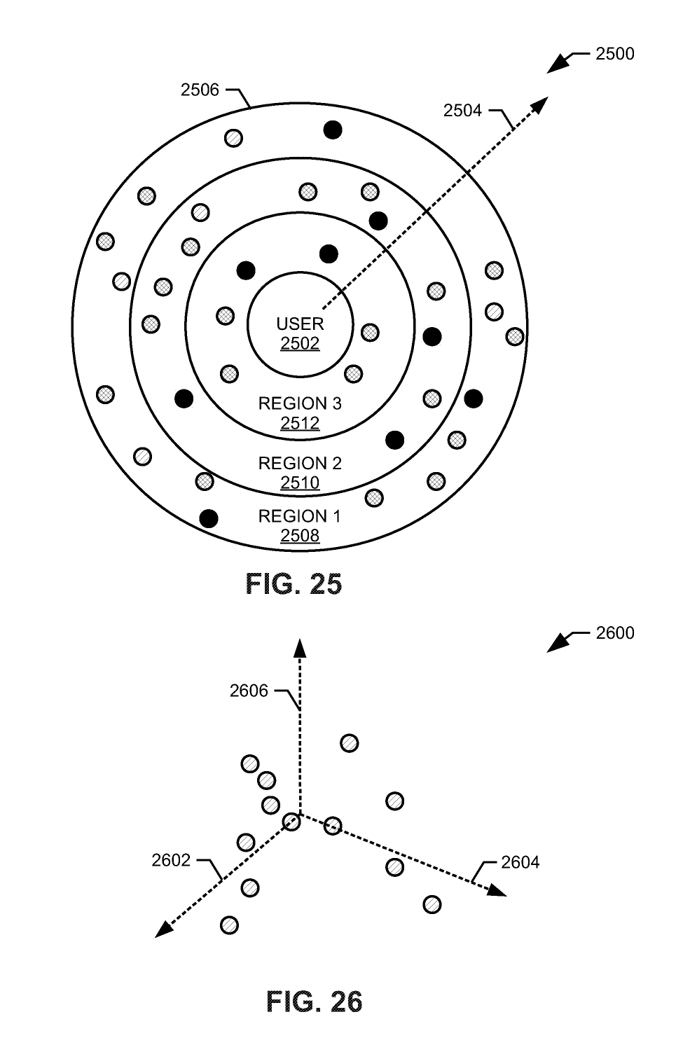

FIG. 26 is a schematic diagram depicting alternate presentations of recommended skills 2600 as determined by an embodiment of career data analysis system 100. In some embodiments, skills are represented by circles with diagonal hatching referenced to a coordinate system comprised of a first axis 2602, a second axis 2604, and a third axis 2606. In particular embodiments, moving along first axis 2602 represents a decaying relevance of matching jobs based on a user (candidate) centered at the origin, moving along second axis 2604 represents a decaying relevance from like professionals based on the user centered at the origin, while moving along third axis 2606 represents a decaying relevance from an incremental value of a skill based on the user centered at the origin. Together, first axis 2602 through third axis 2606 comprise a three-dimensional coordinate system that can be used to measure the relevance of one or more skills as referenced to a candidate's profile.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, by a processing system, data associated with a career path;
receiving, by the processing system, data associated with a candidate's career history; and
determining, by the processing system at least one of a suggested career position or a suggested salary associated with the candidate based on the data associated with the career path and the data associated with the candidate's career history.

2. The method of claim 1, wherein the data associated with the career path includes data associated with at least one of company-specific data, geographic location, local demand and supply information, and company-specific compensation histories.

3. The method of claim 1, wherein the data associated with the candidate's career history includes data associated with at least one of the candidate's career history, the candidate's educational history, the candidate's compensation history, the candidate's current job title, the candidate's current salary, the candidate's skill set, and the candidate's current geographic location.

4. The method of claim 1, further comprising compensating for a dynamically-changing labor market by characterizing spatio-temporal trends associated with at least one of skill sets, supply and availability of at least one skill set, or current trends associated with one or more skill sets in the current labor market.

5. The method of claim 1, further comprising performing progressive and regressive temporal data analysis on data associated with at least one of complementary skill set acquisition, advance within or departure from a company by a candidate, progression of talent flow within at least one company, movement of professionals throughout their careers, career progression of a candidate within a company, progression of individuals out of universities, or geographic migration patterns, wherein results associated with the progressive and temporal data analysis are used to determine backwards feasibility or forwards feasibility associated with a career path.

6. The method of claim 1, further comprising distinguishing between a student candidate and a professional candidate.

7. The method of claim 1, further comprising recommending complementary skills to the candidate that might allow the candidate to potentially increase their market salary.

8. The method of claim 7, wherein recommending complementary skills to the candidate is based on data processing results from an artificial intelligence-based skill recommendation engine.

9. The method of claim 1, further comprising recommending at least one career path that increase the candidate's likelihood of getting a job.

10. The method of claim 9, wherein recommending the at least one career path includes career path projections associated with a time period, wherein the career path projections perform at least one of maximizing the candidate's salary over the time period, the candidate attaining a certain job title within the time period, or maximizing the candidate's cumulative earnings within the time period.

11. The method of claim 1, further comprising recommending a job that increases the likelihood of advancement for the candidate and corresponding salary increases within a company.

12. The method of claim 11, wherein recommending the job is based on data processing results from an artificial intelligence-based skill recommendation engine, wherein the data processing includes data associated with at least one of a career profile associated with the candidate, a skill set associated with the candidate, the candidate's compensation history, the job description, the required qualifications for the job, past trends associated with the job, a geographic location of the candidate or a geographic location of the job.

13. The method of claim 1, wherein the suggested career position is determined by processing data associated with at least one of the candidate's skill set, the candidate's current and past job titles, the candidate's career history, the candidate's work experience, and a job description associated with at least one job, wherein the job description includes a job title, a job description, required qualifications, and a job location.

14. The method of claim 1, wherein determining a suggested salary includes implementing functional estimation methods that analyze job-related features.

15. The method of claim 1, wherein the suggested career position or the suggested salary are personalized to the candidate based on the data associated with the career path and the data associated with the candidate's career history.

16. An apparatus comprising:
a communications module configured to receive data associated with a career path and data associated with a candidate's career history; and
a data analysis module configured to determine at least one of a suggested career position or a salary suggestion for the candidate based on the data associated with the career path and the data associated with the candidate's career history.

17. The apparatus of claim 16, wherein the data analysis module includes a signal extraction module, wherein the signal extraction module is configured to extract at least one signal from the data associated with the career path and the data associated with the candidate's career history, and wherein the signal extraction module is configured to process the at least one signal.

18. The apparatus of claim 17, wherein the signal extraction module, based on processing the at least one signal, provides at least one of salary listings, desirable skill sets, or a listing of jobs that are similar to a current career position associated with the candidate.

19. The apparatus of claim 16, wherein the data analysis module is further configured to present to the candidate at least one nearest professional that has a profile similar to a current profile associated with the candidate, wherein the current profile associated with the candidate includes at least one of job title, educational qualifications, skill set, or career path.

20. The apparatus of claim 16, wherein the data analysis module is further configured to provide an expected mean salary and an expected salary range for the suggested career position.
